(19) United States
(12) Patent Application Publication
(10) Pub. No.: US 2021/0358150 A1
(43) Pub. Date: Nov. 18, 2021

(54) THREE-DIMENSIONAL LOCALIZATION METHOD, SYSTEM AND COMPUTER-READABLE STORAGE MEDIUM

(71) Applicant: GUANGDONG OPPO MOBILE TELECOMMUNICATIONS CORP., LTD., Dongguan (CN)

(72) Inventors: YUAN LIN, Palo Alto, CA (US); FAN DENG, Palo Alto, CA (US); CHIUMAN HO, Palo Alto, CA (US)

(21) Appl. No.: 17/388,998

(22) Filed: Jul. 29, 2021

Related U.S. Application Data
(63) Continuation of application No. PCT/CN2019/106254, filed on Sep. 17, 2019.
(60) Provisional application No. 62/824,654, filed on Mar. 27, 2019.

(51) Int. Cl. G06T 7/521; G06T 7/70; G06T 5/00; G06T 3/40; H04N 5/33

(52) U.S. Cl. CPC G06T 7/521; G06T 7/70; G06T 5/006; G06T 2207/20084; H04N 5/33; G06T 2207/10028; G06T 2207/10048; G06T 3/40

(57) ABSTRACT

Systems and methods are described for three-dimensional localization using light-depth images. For example, some of the methods include accessing a light-depth image, wherein the light-depth image includes a non-visible light depth channel representing distances of objects in a scene viewed from an image capture device, and the light-depth image includes one or more visible light channels that are temporally and spatially synchronized with the depth channel; determining a set of features of the scene in a space based on the light-depth image; accessing a map data structure that includes features based on light data and position data for the objects in the space; accessing matching data derived by matching the set of features of the scene to features of the map data structure; determining a location of the image capture device relative to objects in the space based on the matching data.

### CROSS-REFERENCE TO RELATED APPLICATION

This application is a continuation of a PCT application No. PCT/CN2019/106254 filed on Sep. 17, 2019. The PCT application No. PCT/CN2019/106254 claims priority to a U.S. application No. 62/824,654 filed on Mar. 27, 2019. The contents of the aforementioned applications are incorporated herein by reference.

### TECHNICAL FIELD

This disclosure relates to three-dimensional localization using light-depth images.

### BACKGROUND

Cameras may be used for capturing images (e.g., frames of video) that may be processed using computer vision algorithms for applications, such as, object detection and tracking or facial recognition. The depth information of the object in a space captured in an image can be obtained through deep learning algorithms, and modeling and positioning can be based on the depth information, thereby enriching the functions of cameras.

### SUMMARY

Disclosed herein are implementations of three-dimensional localization using light-depth images.

In a first aspect, the subject matter described in this specification can be embodied in methods that can include, for example, accessing a light-depth image, and the light-depth image may include a non-visible light depth channel representing distances of objects in a scene viewed from an image capture device, and the light-depth image includes one or more visible light channels that are temporally and spatially synchronized with the non-visible light depth channel, wherein the one or more visible light channels may represent light reflected from surfaces of the objects in the scene viewed from the image capture device; determining a set of features of the scene in a space based on the light-depth image, and the set of features can be determined based on the non-visible light depth channel and at least one of the one or more visible light channels; accessing a map data structure that includes features based on light data and position data for the objects in the space, and the position data may include non-visible light depth channel data, and the light data may include the at least one of one or more visible light channels data; obtaining matching data derived by matching the set of features of the scene to features of the map data structure; and, determining a location of the objects in the space based on the matching data.

In a second aspect, the subject matter described in this specification can be embodied in computer-readable medium that can include, for example, a hyper-hemispherical non-visible light projector, a hyper-hemispherical non-visible light sensor, a hyper-hemispherical visible light sensor, one or more processors; and a memory, one or more programs, and the one or more programs including instructions can be stored in the memory and configured to be executed by the one or more processors for: accessing a light-depth image that is captured using the hyper-hemispherical non-visible light sensor and the hyper-hemispherical visible light sensor, and the light-depth image may include a non-visible light depth channel representing distances of objects in a scene viewed from an image capture device that includes the hyper-hemispherical non-visible light sensor, and the hyper-hemispherical visible light sensor, and the light-depth image includes one or more visible light channels that are temporally and spatially synchronized with the depth channel, wherein the one or more visible light channels may represent light reflected from surfaces of the objects in the scene viewed from the image capture device; determining a set of features of the scene in a space based on the light-depth image, and the set of features can be determined based on the non-visible light depth channel and at least one of the one or more visible light channels; accessing a map data structure that includes features based on light data and position data for the objects in the space; and the position data may include non-visible light depth channel data, and the light data includes at least one of the one or more visible light channels data; accessing matching data derived by matching the set of features of the scene to features of the map data structure; and, determining a location of the objects in the space based on the matching data.

In a third aspect, the subject matter described in this specification can be embodied in computer-readable medium that includes one or more processors; a memory; and one or more programs, and the one or more programs including instructions can be stored in the memory and configured to be executed by the one or more processors for: accessing a light-depth image that is captured using the hyper-hemispherical non-visible light sensor and the hyper-hemispherical visible light sensor, and the light-depth image may include a non-visible light depth channel representing distances of objects in a scene viewed from an image capture device that includes a hyper-hemispherical non-visible light sensor, a hyper-hemispherical non-visible light projector and a hyper-hemispherical visible light sensor, and the light-depth image includes one or more visible light channels that are temporally and spatially synchronized with the depth channel, wherein the one or more visible light channels may represent light reflected from surfaces of the objects in the scene viewed from the image capture device; determining a set of features of the scene in a space based on the light-depth image, and the set of features can be determined based on the depth channel and at least one of the one or more light channels; accessing a map data structure that includes features based on light data and position data for the objects in the space; and the position data may include depth channel data, and the light data includes at least one of the one or more light channels data; accessing matching data derived by matching the set of features of the scene to features of the map data structure; and determining a location of the objects in the space based on the matching data.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an example of a user device for digital computing and electronic communication in accordance with this disclosure.

FIG. 2 is a block diagram of a system for fisheye non-visible light depth detection in accordance with this disclosure.

FIG. 3 is a diagram of an example of a hemispherical fisheye non-visible light depth detection device in accordance with this disclosure.

FIG. 4 is a diagram of another example of a hemispherical fisheye non-visible light depth detection device in accordance with this disclosure.

FIG. 5 is a diagram of an example of a hemispherical-fisheye non-visible-light-depth-detection unit in accordance with this disclosure.

FIG. 6 is a diagram of an example of a hemispherical fisheye non-visible light detection unit in accordance with this disclosure.

FIG. 7 is a diagram of an example of a hemispherical fisheye non-visible light flood projection unit in accordance with this disclosure.

FIG. 8 is a diagram of an example of a spherical fisheye non-visible light depth detection device in accordance with this disclosure.

FIG. 9 is a diagram of another example of a spherical fisheye non-visible light depth detection device in accordance with this disclosure.

FIG. 10 is a diagram of an example of a spherical fisheye non-visible light projection unit in accordance with this disclosure.

FIG. 11 is a diagram of an example of a spherical fisheye non-visible light detection unit in accordance with this disclosure.

FIG. 12 is a diagram of an example of fisheye non-visible light depth detection in accordance with this disclosure.

FIG. 13 is a block diagram of an example of a system for three-dimensional localization using light-depth images in accordance with this disclosure.

FIG. 14 is a flow chart of an example of a process for three-dimensional localization of a device using light-depth images captured using the device in accordance with this disclosure.

FIG. 15 is a flow chart of an example of a process for generating a route based on localization data in accordance with this disclosure.

FIG. 16 is a flow chart of an example of a process for three-dimensional localization of an object using light-depth images in accordance with this disclosure.

FIG. 17A is a block diagram of an example of a system configured for capture of light-depth images in accordance with this disclosure.

FIG. 17B is a block diagram of an example of a system configured for capture of light-depth images in accordance with this disclosure.

### DETAILED DESCRIPTION

Light sensors, such as cameras, may be used for a variety of purposes, including capturing images or video, object detection and tracking, facial recognition, and the like. Wide angle, or ultrawide-angle lenses, such as fisheye lenses, allow cameras to capture panoramic or hemispherical scenes. Dual fisheye lens cameras arranged in opposite directions along an optical axis allow a camera device to capture spherical images.

In some systems, visible light sensors, such as cameras, are used to determine depth information corresponding to a distance between the camera apparatus and respective external objects in the captured scene. For example, some cameras implement stereovision, or binocular, depth detection, wherein multiple overlapping images captured by multiple, spatially separate, cameras are evaluated to determine depth based on disparities between the content captured by the images. The resource costs, including multiple cameras and computational costs, may be high and the accuracy of binocular depth detection may be limited. The three-dimensional depth detection capabilities of cameras may be limited based on the respective field of view.

Spherical or hemispherical non-visible light depth detection may improve the accuracy and efficiency of non-hemispherical depth detection and visible light depth detection, by projecting a non-visible light, such as infrared, spherical or hemispherical static dot cloud pattern, detecting reflected non-visible light using a spherical or hemispherical non-visible light detector, and determining three-dimensional depth based on a function of the received light corresponding to the projected static dot cloud pattern.

Three-dimensional maps or models representing the operational environment of the user device may be used, for example, for augmented reality or virtual reality implementations. Generating three-dimensional maps or models generated using images captured by a camera having a limited, such as rectilinear or otherwise less than hemispherical, field of view may be inefficient and inaccurate. For example, generating a three-dimensional map or model using images captured by a camera having a limited, such as rectilinear or otherwise less than hemispherical, field of view may include using multiple image capture units, or positioning, such as manually, an image capture unit in a sequence of positions over time, to generate multiple images, and merging the multiple images to inefficiently and inaccurately generate the model.

Three-dimensional modeling using hyper-hemispherical (e.g., hemispherical or spherical) visible light-depth images, which may include fisheye depth detection, may improve the efficiency, speed, and accuracy of three-dimensional modeling relative to three-dimensional modeling based on limited, such as rectilinear or otherwise less than hyper-hemispherical, images. Three-dimensional modeling using hyper-hemispherical visible light-depth images may use fewer images and may include fewer image stitching operations. Three-dimensional modeling using hyper-hemispherical (e.g., hemispherical or spherical) visible light-depth images may increase the availability of feature information per image.

Three-dimensional localization may be used when a person needs to find his location in un-familiar places (e.g., a large shopping mall, a parking lot, or an airport), emergency situations (e.g., find safest and shortest route to exit a building on fire), or when a person needs to quickly locate items (e.g., commodities in a grocery store or personal items in a room). On the other hand, the current fisheye camera has an ultra-wide-angle camera that intends to create a wide panoramic or hyper-hemispherical image but lacks the ability to effectively obtain the depth information of the surrounding objects. Systems and methods are described herein for fast and accurate three-dimensional localization technique using a fisheye depth camera.

The proposed fisheye depth camera has a larger view than the current depth camera and it can help quickly scan the real 3D environments and reconstruct them as a virtual model for augmented reality and/or virtual reality for localization purpose. Some examples may include localizing position in a building, such as an airport, a parking lot, a train station, or a large shopping mall. With a pre-reconstructed 3D virtual model of a large building, the fisheye depth camera can help quickly localize one's position and help navigate through it. The fisheye depth camera acts as the 3D laser scanner of a device. This application is very useful in emergency situations, as landscape can be significantly changed. The emergency situations include natural disasters, e.g., fire, earthquake, flood, human factors, such as routes are blocked by crowds, cars, and other dangerous factors, such as location of the killers. For example, a person is in a building on fire. The fisheye depth camera can quickly localize the user's location, update the surrounding environment to a public shared virtual model, and find the safest and shortest route to exit the building. Here by updating the public shared virtual model, people can better understand the overall situation and avoid wasting time in trying unsafe or blocked routes. Other applications may include localizing commodities in a grocery store or shopping mall or localizing personal items.

While the disclosure has been described in connection with certain embodiments, the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

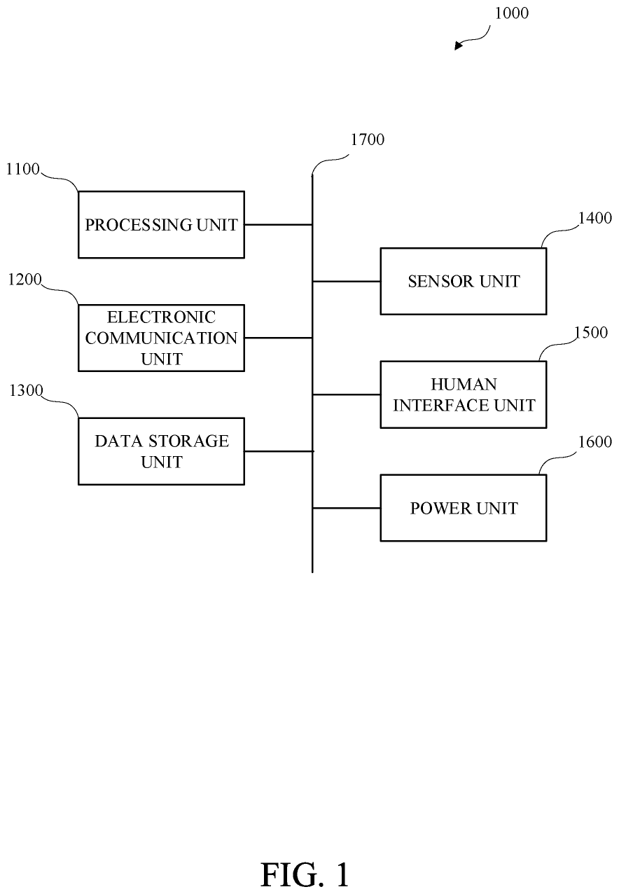

FIG. 1 shows an example of a user device for digital computing and electronic communication 1000 in accordance with this disclosure. The user device for digital computing and electronic communication 1000 includes an electronic processing unit 1100, an electronic communication interface unit 1200, a data storage unit 1300, a sensor unit 1400, a human interface unit 1500, a power unit 1600, and an internal signal distribution unit 1700. The user device for digital computing and electronic communication 1000 may implement one or more aspects or elements of the methods and systems described herein. In some embodiments, the user device for digital computing and electronic communication 1000 may include other components not shown in FIG. 1. For example, the user device for digital computing and electronic communication 1000 may include a housing or enclosure, and the electronic processing unit 1100, the electronic communication interface unit 1200, the data storage unit 1300, the sensor unit 1400, the human interface unit 1500, the power unit 1600, the internal signal distribution unit 1700, or a combination thereof, may be included in the housing.

Although FIG. 1 shows each of the electronic processing unit 1100, the electronic communication interface unit 1200, the data storage unit 1300, the sensor unit 1400, the human interface unit 1500, the power unit 1600, and the internal signal distribution unit 1700 as respective individual units, the user device for digital computing and electronic communication 1000 may include any number of electronic processing units, electronic communication interface units, data storage units, sensor units, human interface units, power units, and internal signal distribution units.

The electronic processing unit 1100, or processor, is operable to receive data, process, and output data. For example, the electronic processing unit 1100 may receive data from the data storage unit 1300, the sensor unit 1400, the electronic communication interface unit 1200, the human interface unit 1500, or a combination thereof. Receiving data may include receiving computer instructions, such as computer instructions stored in the data storage unit 1300 via the internal signal distribution unit 1700. Processing data may include processing or executing computer instructions, such as to implement or perform one or more elements or aspects of the techniques disclosed herein. The electronic processing unit may output data to the data storage unit 1300, the sensor unit 1400, the electronic communication interface unit 1200, the human interface unit 1500, or a combination thereof, via the via the internal signal distribution unit 1700. The electronic processing unit 1100 may be operable to control one or more operations of the user device for digital computing and electronic communication 1000.

The electronic communication interface unit 1200 may communicate, such as receive, transmit, or both, signals, such as data signals, with external devices or systems using wired or wireless electronic communication protocols, such as a near-field communication (NFC) electronic communication protocol, a Bluetooth electronic communication protocol, an 802.11 electronic communication protocol, an infrared (IR) electronic communication protocol, or any other electronic communication protocol.

The data storage unit 1300 may store data, retrieve data, or both. For example, the data storage unit 1300 may retrieve computer instructions and other data. The data storage unit 1300 may include persistent memory, such as a hard-drive. The data storage unit 1300 may include volatile memory, such as one or more random-access memory units.

The sensor unit 1400 may capture, detect, or determine one or more aspects of the operational environment of the user device for digital computing and electronic communication 1000. For example, the sensor unit 1400 may include one or more cameras, or other visible or non-visible light detection and capture units. The sensor unit 1400 may communicate sensor signals, such as captured image data, representing the sensed aspects of the operational environment of the user device for digital computing and electronic communication 1000 to the internal signal distribution unit 1700, the power unit 1600, the data storage unit 1300, the electronic processing unit 1100, the electronic communication interface unit 1200, the human interface unit 1500, or a combination thereof. In some embodiments, the user device for digital computing and electronic communication 1000 may include multiple sensor units, such as a camera, a microphone, an infrared receiver, a global positioning system unit, a gyroscopic sensor, an accelerometer, a pressure sensor, a capacitive sensor, a biometric sensor, a magnetometer, a radar unit, a lidar (light detection and ranging) unit, an ultrasound unit, a temperature sensor, or any other sensor capable of capturing, detecting, or determining one or more aspects or conditions of the operational environment of the user device for digital computing and electronic communication 1000.

The human interface unit 1500 may receive user input. The human interface unit 1500 may communicate data representing the user input to the internal signal distribution unit 1700, the power unit 1600, the data storage unit 1300, the electronic processing unit 1100, the sensor unit 1400, the electronic communication interface unit 1200, or a combination thereof. The human interface unit 1500, may output, present, or display data, or representations thereof, such as to a user of the user device for digital computing and electronic communication 1000. For example, the human interface unit 1500 may include a light-based display, a sound-based display, or a combination thereof.

The power unit 1600 may supply power to the internal signal distribution unit 1700, the data storage unit 1300, the electronic processing unit 1100, the sensor unit 1400, the electronic communication interface unit 1200, and the human interface unit 1500, such as via the internal signal distribution unit 1700 or via an internal power signal distribution unit (not separately shown). For example, the power unit 1600 may be a battery. In some embodiments, the power unit 1600 may include an interface with an external power source.

The internal signal distribution unit 1700 may carry or distribute internal data signals, power signals, or both, such as to the electronic processing unit 1100, the electronic communication interface unit 1200, the data storage unit 1300, the sensor unit 1400, the human interface unit 1500, the power unit 1600, or a combination thereof.

Other implementations of configurations of the user device for digital computing and electronic communication 1000 may be used. For example, the user device for digital computing and electronic communication 1000 may omit the electronic communication interface unit 1200.

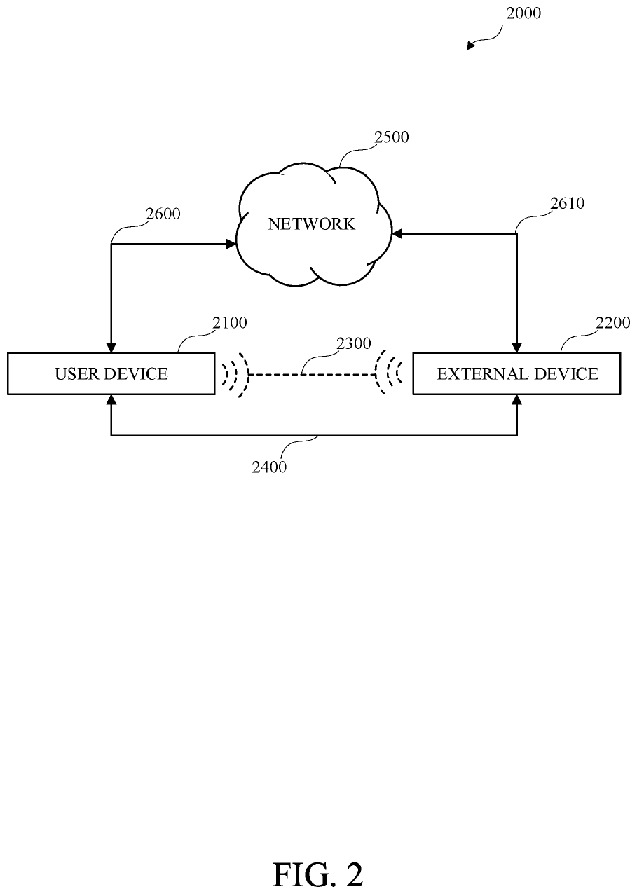

FIG. 2 shows a block diagram of a system for fisheye non-visible light depth detection 2000 in accordance with this disclosure. As shown, the system for fisheye non-visible light depth detection 2000 includes a user device 2100, such as the user device for digital computing and electronic communication 1000 shown in FIG. 1. In FIG. 2, the user device 2100 is shown in electronic communication with an external device 2200, as indicated by the broken lines at 2300. The external device 2200 may be similar to the user device for digital computing and electronic communication 1000 shown in FIG. 1, except as described herein or otherwise clear from context. In some embodiments, the external device 2200 may be a server or other infrastructure device.

The user device 2100 may communicate with the external device 2200 directly via a wired or wireless electronic communication medium 2400. The user device 2100 may communicate with the external device 2200 directly via a network 2500, such as the Internet, or via a combination networks (not separately shown). For example, the user device 2100 may communicate via the network 2500 using a first network communication link 2600 and the external device may communicate via the network 2500 using a second network communication link 2610.

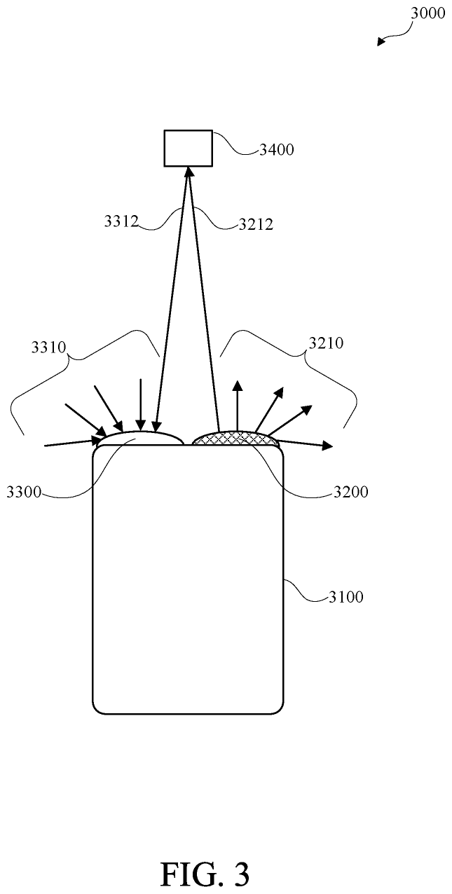

FIG. 3 shows a diagram of an example of a hemispherical fisheye non-visible light depth detection device 3000 in accordance with this disclosure. The hemispherical fisheye non-visible light depth detection device 3000, or fisheye depth camera, may be similar to a user device, such as the user device for digital computing and electronic communication 1000 shown in FIG. 1, except as described herein or otherwise clear from context. The hemispherical fisheye non-visible light depth detection device 3000 may be a fisheye camera, which is an ultra-wide-angle camera, and which may capture panoramic or hemispherical images. The hemispherical fisheye non-visible light depth detection device 3000 may be a depth camera, which may capture or determine depth information of a captured scene.

The hemispherical-fisheye non-visible-light-depth-detection device 3000 includes a device housing 3100, a hemispherical-fisheye non-visible-light-depth-detection unit 3200, and a fisheye non-visible light detection unit 3300.

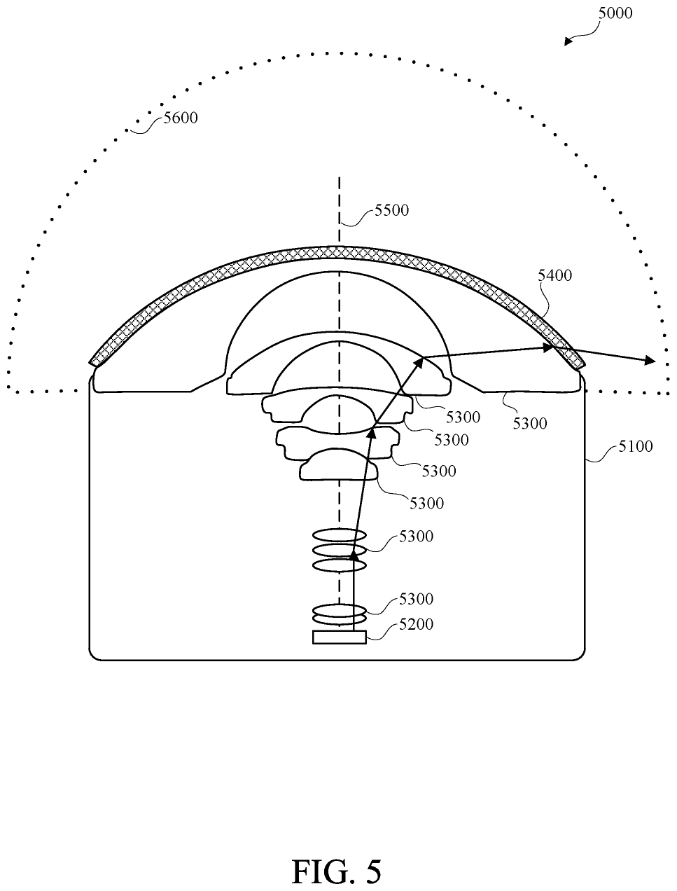

The hemispherical-fisheye non-visible-light-depth-detection unit 3200 may be a fisheye infrared dot projector. The hemispherical-fisheye non-visible-light-depth-detection unit 3200 may project or emit non-visible light, such as infrared light, in a point pattern, such as a static dot cloud pattern, as indicated by the directional lines 3210 extending from the surface of the hemispherical-fisheye non-visible-light-depth-detection unit 3200. Although five directional lines 3210 are shown extending from the surface of the hemispherical-fisheye non-visible-light-depth-detection unit 3200 for simplicity and clarity, the non-visible light static dot cloud pattern projected by the hemispherical-fisheye non-visible-light-depth-detection unit 3200 may have a field of projection of 360 degrees longitudinally and 180 degrees, or greater, laterally, such as 183 degrees. An example of the hemispherical-fisheye non-visible-light-depth-detection unit 3200 is shown in FIG. 5. In some embodiments, such as panoramic embodiments, the longitudinal field may be less than 360 degrees.

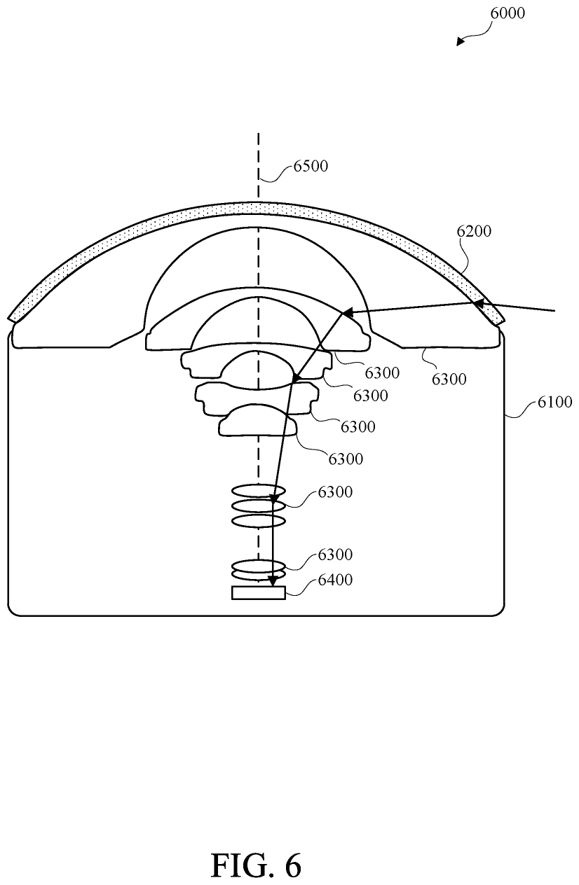

The fisheye non-visible light detection unit 3300 may be a fisheye infrared camera. The fisheye non-visible light detection unit 3300 may detect or receive non-visible light, such as infrared light as indicated by the directional lines 3310 converging on the surface of the fisheye non-visible light detection unit 3300. For example, the fisheye non-visible light detection unit 3300 may receive non-visible light emitted by the hemispherical-fisheye non-visible-light-depth-detection unit 3200 in the static dot cloud pattern and reflected to the fisheye non-visible light detection unit 3300 by aspects the environment, such as objects in the field of view of the fisheye non-visible light detection unit 3300. Although five directional lines 3210 are shown converging on the surface of the fisheye non-visible light detection unit 3300 for simplicity and clarity, the fisheye non-visible light detection unit 3300 may have a field of view of 360 degrees longitudinally and 180 degrees, or greater, laterally, such as 183 degrees. An example of the fisheye non-visible light detection unit 3300 is shown in FIG. 6.

The hemispherical fisheye non-visible light depth detection device 3000 may perform fisheye non-visible light depth detection by emitting non-visible light in a static dot cloud pattern using the hemispherical-fisheye non-visible-light-depth-detection unit 3200 and detecting corresponding reflected non-visible light using the fisheye non-visible light detection unit 3300 (detected reflected non-visible light).

For example, FIG. 3 show an external object 3400 in the environment of the hemispherical fisheye non-visible light depth detection device 3000, such as in the field of projection of the hemispherical-fisheye non-visible-light-depth-detection unit 3200 and the field of view of the fisheye non-visible light detection unit 3300. Non-visible light may be emitted by the hemispherical-fisheye non-visible-light-depth-detection unit 3200 toward the external object 3400 as indicated by the directional line 3212. The non-visible light may be reflected by a surface of the external object 3400 toward the fisheye non-visible light detection unit 3300 as indicated by the directional line 3312 and may be captured or recorded by the fisheye non-visible light detection unit 3300.

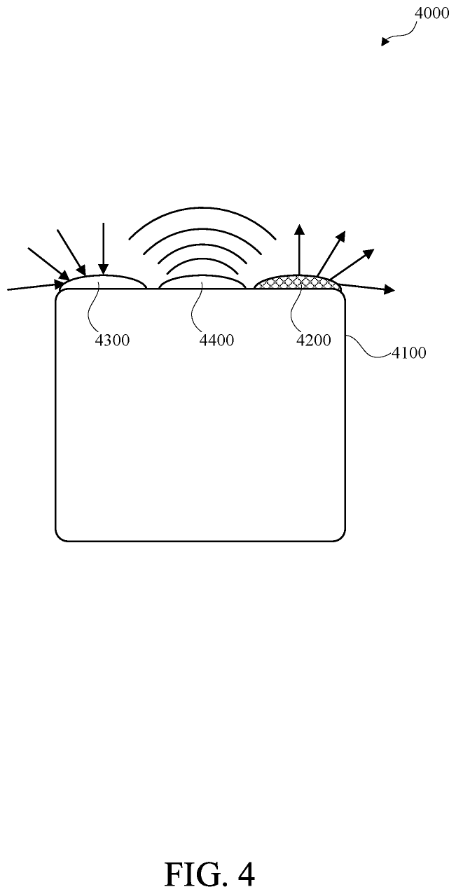

FIG. 4 shows a diagram of another example of a hemispherical fisheye non-visible light depth detection device 4000 in accordance with this disclosure. The hemispherical fisheye non-visible light depth detection device 4000 may be similar to the hemispherical fisheye non-visible light depth detection device 3000 shown in FIG. 3, except as described herein or otherwise clear from context.

The hemispherical fisheye non-visible light depth detection device 4000 includes a device housing 4100, a hemispherical-fisheye non-visible-light-depth-detection unit 4200, a hemispherical fisheye non-visible light detection unit 4300, and a hemispherical fisheye non-visible light flood projection unit 4400.

The device housing 4100 may be similar to the device housing 3100 shown in FIG. 3, except as described herein or otherwise clear from context. The hemispherical-fisheye non-visible-light-depth-detection unit 4200 may be similar to the hemispherical-fisheye non-visible-light-depth-detection unit 3200 shown in FIG. 3, except as described herein or otherwise clear from context. The hemispherical fisheye non-visible light detection unit 4300, may be similar to the fisheye non-visible light detection unit 3300 shown in FIG. 3, except as described herein or otherwise clear from context.

The hemispherical fisheye non-visible light flood projection unit 4400, or infrared flood illuminator, may be similar to the hemispherical-fisheye non-visible-light-depth-detection unit 3200 shown in FIG. 3, except as described herein or otherwise clear from context. The hemispherical fisheye non-visible light flood projection unit 4400 may emit a diffuse, even, field of non-visible light, such as infrared light, as indicated by the arced lines extending from the surface of the hemispherical fisheye non-visible light flood projection unit 4400. The diffuse field of non-visible light emitted by the hemispherical fisheye non-visible light flood projection unit 4400 may non-visibly illuminate the environment of the hemispherical fisheye non-visible light depth detection device 4000, which may include illuminating external objects proximate to the hemispherical fisheye non-visible light depth detection device 4000.

The hemispherical fisheye non-visible light detection unit 4300 may receive non-visible light emitted by the hemispherical fisheye non-visible light flood projection unit 4400 and reflected by the external objects in the environment of the hemispherical fisheye non-visible light depth detection device 4000, such as for use in a liveness test portion of a facial recognition method or in a feature extraction portion of a simultaneous localization and mapping (SLAM) method. Depth detection based on received reflected non-visible light emitted from the hemispherical fisheye non-visible light flood projection unit 4400 may inaccurate, inefficient, or both.

FIG. 5 shows a diagram of an example of a hemispherical-fisheye non-visible-light-depth-detection unit 5000 in accordance with this disclosure. A fisheye non-visible light depth detection device, such as the hemispherical fisheye non-visible light depth detection device 3000 shown in FIG. 3, or the hemispherical fisheye non-visible light depth detection device 4000 shown in FIG. 4, may include the hemispherical-fisheye non-visible-light-depth-detection unit 5000. For example, the hemispherical-fisheye non-visible-light-depth-detection unit 3200 of the hemispherical fisheye non-visible light depth detection device 3000 shown in FIG. 3 may be implemented as the hemispherical-fisheye non-visible-light-depth-detection unit 5000.

The hemispherical-fisheye non-visible-light-depth-detection unit 5000 includes an enclosure 5100, a non-visible light source 5200, one or more lenses 5300, and a diffractive optical element (DOE) 5400. The hemispherical-fisheye non-visible-light-depth-detection unit 5000 has an optical axis, as indicated by the broken line at 5500.

The non-visible light source 5200 may be an infrared light source such as a vertical-cavity surface-emitting laser (VCSEL). The non-visible light generated by the non-visible light source 5200 is refracted by the lenses 5300 to form a field of projection of 360 degrees longitudinally and 180 degrees, or greater, laterally, such as 183 degrees. The non-visible light forming the field of projection is rectified to form static dot cloud pattern by the diffractive optical element 5400, as indicated by the dotted line arc at 5600. An indication of an example light path is indicated by the directional lines extending from the non-visible light source 5200 and passing through the lenses 5300 and passing through and extending from the diffractive optical element 5400. In some embodiments, the diffractive optical element 5400 may be omitted and the hemispherical-fisheye non-visible-light-depth-detection unit 5000 may include a dot cloud mask that may form the static dot cloud pattern from the non-visible light generated by the non-visible light source 5200 and refracted by the lenses 5300.

In an example, the non-visible light source 5200 may be an infrared light source that may generate infrared light (photons) having a defined wavelength, such as 940 nm. Infrared light having a 940 nm wavelength may be absorbed by water in the atmosphere and using infrared light having a 940 nm wavelength may improve performance and accuracy of fisheye non-visible light depth perception, such as in outdoor conditions. Other wavelengths, such as 850 nm, or another infrared or near-infrared wavelength, such as a wavelength in the range 0.75 μm to 1.4 may be used. In this context, a defined wavelength of 940 nm may indicate light narrowly spread around 940 nm. The use of light at the defined wavelength of 940 nm may reduce resource costs and reduce the chromatic aberration relative visible light.

The non-visible light source 5200 generates the non-visible light in a plane and the combination of the lenses 5300 and the diffractive optical element 5400 maps the light emitted by non-visible light source 5200 to the spherically distributed static dot cloud pattern.

The number and configuration of the lenses 5300 shown in FIG. 5 is shown for simplicity and clarity. Other numbers and configurations of lenses may be used. The optical construction of the lenses 5300, such as the respective shapes, materials, or both, of these lenses 5300 is optimized according to the refractive index of the non-visible light generated by the non-visible light source 5200.

FIG. 6 shows a diagram of an example of a hemispherical fisheye non-visible light detection unit 6000 in accordance with this disclosure. A fisheye non-visible light depth detection device, such as the hemispherical fisheye non-visible light depth detection device 3000 shown in FIG. 3, or the hemispherical fisheye non-visible light depth detection device 4000 shown in FIG. 4, may include the hemispherical fisheye non-visible light detection unit 6000. For example, the fisheye non-visible light detection unit 3300 of the hemispherical fisheye non-visible light depth detection device 3000 shown in FIG. 3 may be implemented as the hemispherical fisheye non-visible light detection unit 6000.

The hemispherical fisheye non-visible light detection unit 6000 includes an enclosure 6100, a non-visible light pass filter 6200, one or more lenses 6300, and a non-visible light receiver 6400. The hemispherical fisheye non-visible light detection unit 6000 has an optical axis, as indicated by the broken line at 6500, and a field of view (not shown) of 360 degrees longitudinally and 180 degrees, or greater, laterally, centered on the optical axis 6500.

The non-visible light pass filter 6200 may receive light, which may include non-visible light, such as infrared light. For example, the non-visible light pass filter 6200 may receive infrared light from a static dot cloud pattern reflected by proximate external objects (not shown) subsequent to emission from a non-visible light projection unit, such as the hemispherical-fisheye non-visible-light-depth-detection unit 5000 shown in FIG. 5.

The light received by the non-visible light pass filter 6200 is filtered by the non-visible light pass filter 6200 to exclude visible light and pass through non-visible light. The non-visible light passed through the non-visible light pass filter 6200 is focused on the non-visible light receiver 6400 by the lenses 6300. The combination of the non-visible light pass filter 6200 and the lenses 6300 maps the hemispherical field of view of the hemispherical fisheye non-visible light detection unit 6000 to the plane of the non-visible light receiver 6400. The non-visible light receiver 6400 may be an infrared light receiver.

The number and configuration of the lenses 6300 shown in FIG. 6 is shown for simplicity and clarity. Other numbers and configurations of lenses may be used. The optical construction of the lenses 6300, such as the respective shapes, materials, or both, of these lenses 6300 is optimized according to the refractive index of the non-visible light received by the non-visible light receiver 6400.

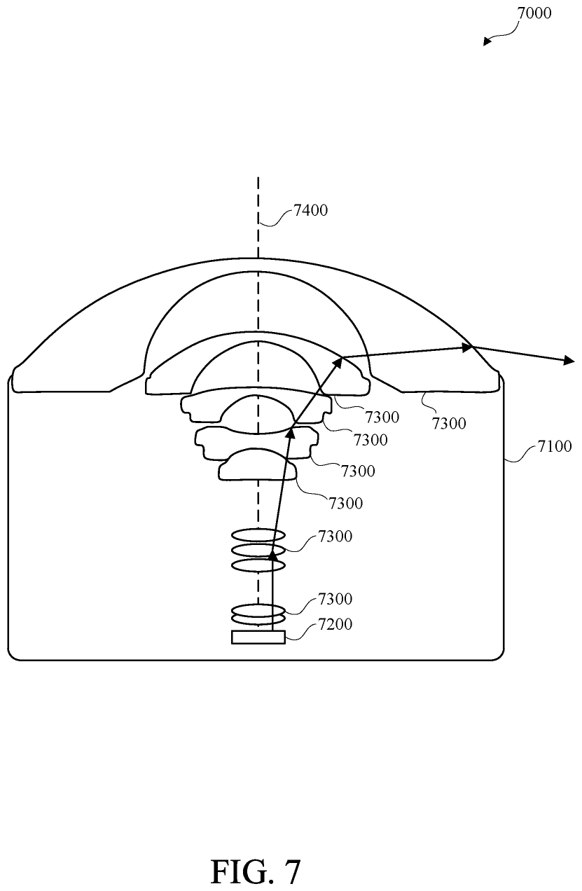

FIG. 7 shows a diagram of an example of a hemispherical fisheye non-visible light flood projection unit 7000 in accordance with this disclosure. A fisheye non-visible light depth detection device, such as the hemispherical fisheye non-visible light depth detection device 3000 shown in FIG. 3, or the hemispherical fisheye non-visible light depth detection device 4000 shown in FIG. 4, may include the hemispherical fisheye non-visible light flood projection unit 7000. For example, the hemispherical fisheye non-visible light flood projection unit 4400 of the hemispherical fisheye non-visible light depth detection device 4000 shown in FIG. 4 may be implemented as the hemispherical fisheye non-visible light flood projection unit 7000.

The hemispherical fisheye non-visible light flood projection unit 7000 includes an enclosure 7100, a non-visible light source 7200, and one or more lenses 7300. The hemispherical fisheye non-visible light flood projection unit 7000 has an optical axis, as indicated by the broken line at 7400. An indication of an example light path is indicated by the directional lines extending from the non-visible light source 7200 and passing through and extending from the lenses 7300.

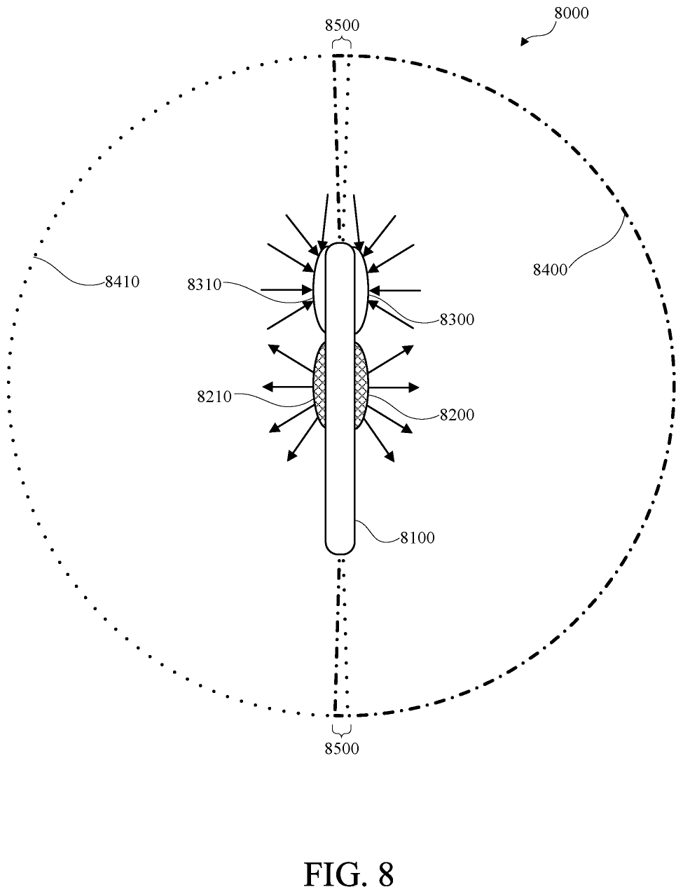

FIG. 8 shows a diagram of an example of a spherical fisheye non-visible light depth detection device 8000 in accordance with this disclosure. The spherical fisheye non-visible light depth detection device 8000, or fisheye depth camera, may be similar to the hemispherical fisheye non-visible light depth detection device 3000 shown in FIG. 3, except as described herein or otherwise clear from context. The spherical fisheye non-visible light depth detection device 8000 may be a dual-fisheye camera, which is an omnidirectional camera, and which may capture panoramic or spherical images. The spherical fisheye non-visible light depth detection device 8000 may be a depth camera, which may capture or determine depth information of a captured scene.

The spherical fisheye non-visible light depth detection device 8000 includes a device housing 8100, a first hemispherical-fisheye non-visible-light-depth-detection unit 8200, a second hemispherical-fisheye non-visible-light-depth-detection unit 8210, a first hemispherical fisheye non-visible light detection unit 8300, and a second hemispherical fisheye non-visible light detection unit 8310.

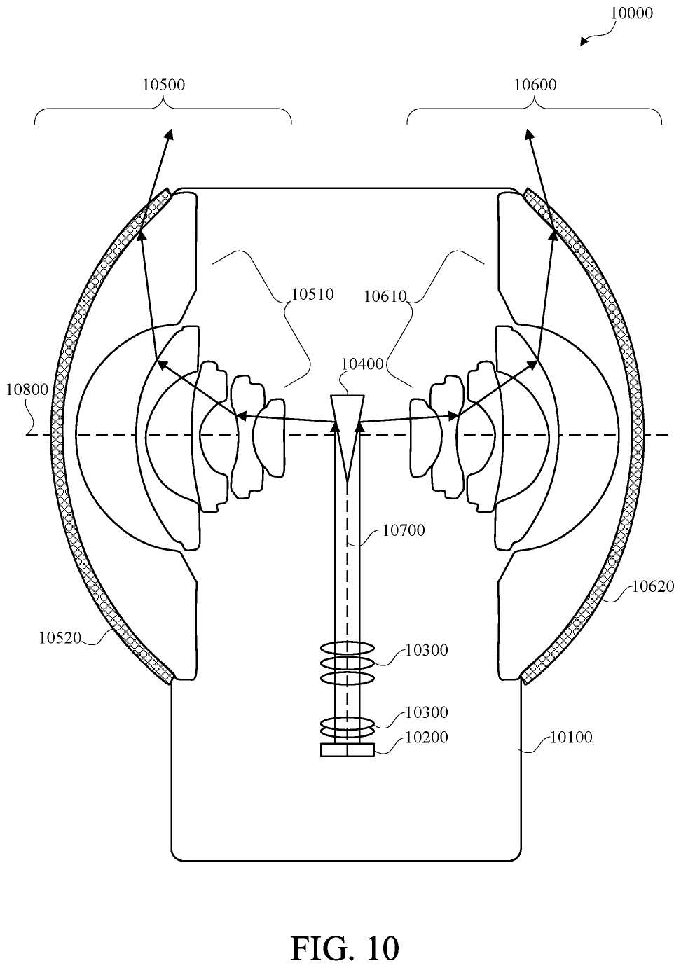

In some embodiments, the first hemispherical-fisheye non-visible-light-depth-detection unit 8200 may be a first portion of a spherical fisheye non-visible light projection unit and the second hemispherical-fisheye non-visible-light-depth-detection unit 8210 may be a second portion of the spherical fisheye non-visible light projection unit. An example of a spherical fisheye non-visible light projection unit is shown in FIG. 10.

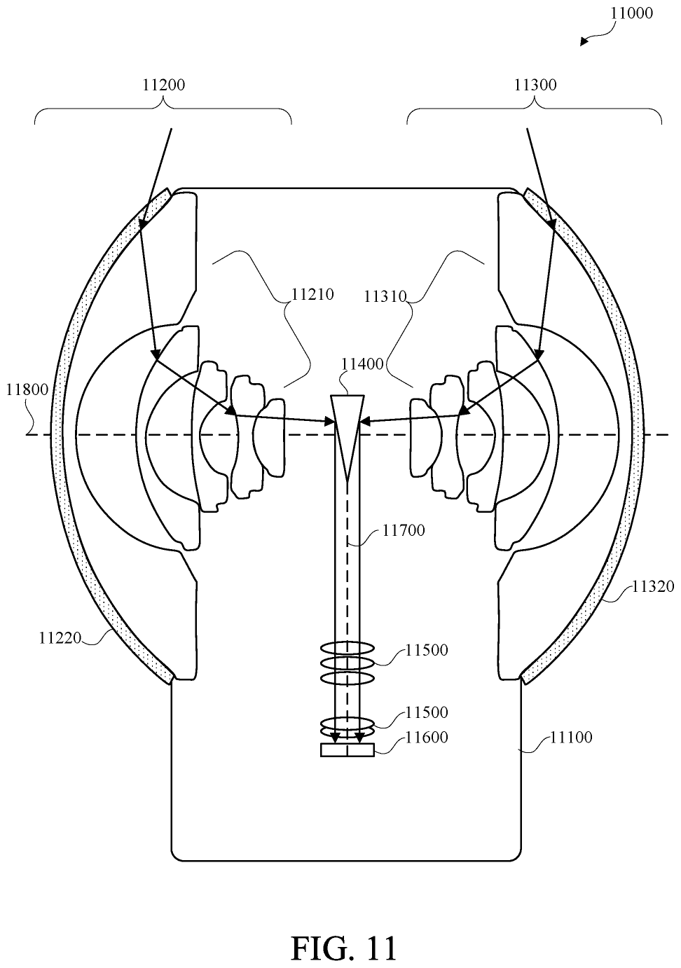

In some embodiments, the first hemispherical fisheye non-visible light detection unit 8300 may be a first portion of a spherical fisheye non-visible light detection unit and the second hemispherical fisheye non-visible light detection unit 8310 may be a second portion of the spherical fisheye non-visible light detection unit. An example of a spherical fisheye non-visible light detection unit is shown in FIG. 11.

The first hemispherical-fisheye non-visible-light-depth-detection unit 8200 may be similar to the hemispherical-fisheye non-visible-light-depth-detection unit 3200 shown in FIG. 3, except as described herein or otherwise clear from context. The second hemispherical-fisheye non-visible-light-depth-detection unit 8210 may be similar to the hemispherical-fisheye non-visible-light-depth-detection unit 3200 shown in FIG. 3, except as described herein or otherwise clear from context.

The field of projection of the first hemispherical-fisheye non-visible-light-depth-detection unit 8200 is indicated by the dot-dash line arc at 8400. The field of projection of the second hemispherical-fisheye non-visible-light-depth-detection unit 8210 is indicated by the dotted line arc at 8410. The field of projection of the first hemispherical-fisheye non-visible-light-depth-detection unit 8200 may partially overlap the field of projection of the second hemispherical-fisheye non-visible-light-depth-detection unit 8210 to form a combined field of projection that is a 360-degree omnidirectional field of projection. The first hemispherical-fisheye non-visible-light-depth-detection unit 8200 and the second hemispherical-fisheye non-visible-light-depth-detection unit 8210 may collectively project or emit a 360-degree omnidirectional static dot cloud pattern.

In some embodiments, a portion of the hemispherical portion of the omnidirectional static dot cloud pattern projected by the first hemispherical-fisheye non-visible-light-depth-detection unit 8200 may overlap with a portion of the hemispherical portion of the omnidirectional static dot cloud pattern projected by the second hemispherical-fisheye non-visible-light-depth-detection unit 8210 as indicated at 8500. To avoid ambiguity or conflict between the respective projected static dot cloud patterns in the overlapping portions the hemispherical portion of the omnidirectional static dot cloud pattern projected by the first hemispherical-fisheye non-visible-light-depth-detection unit 8200 may differ from the hemispherical portion of the omnidirectional static dot cloud pattern projected by the second hemispherical-fisheye non-visible-light-depth-detection unit 8210. For example, the hemispherical portion of the omnidirectional static dot cloud pattern projected by the first hemispherical-fisheye non-visible-light-depth-detection unit 8200 may use circular dots of non-visible light and the hemispherical portion of the omnidirectional static dot cloud pattern projected by the second hemispherical-fisheye non-visible-light-depth-detection unit 8210 may use square dots of non-visible light. In another example, the light projection by the respective hemispherical-fisheye non-visible-light-depth-detection units 8200, 8210 may be time duplex multiplexed. Other multiplexing techniques may be used.

The field of view of the first hemispherical fisheye non-visible light detection unit 8300 may partially overlap the field of view of the second hemispherical fisheye non-visible light detection unit 8310 to form a combined field of view that is a 360-degree omnidirectional field of view. The first hemispherical fisheye non-visible light detection unit 8300 and the second hemispherical fisheye non-visible light detection unit 8310 may collectively receive or detect reflected light corresponding to a 360-degree omnidirectional static dot cloud pattern, such as the 360-degree omnidirectional static dot cloud pattern projected by the first hemispherical-fisheye non-visible-light-depth-detection unit 8200 and the second hemispherical-fisheye non-visible-light-depth-detection unit 8210.

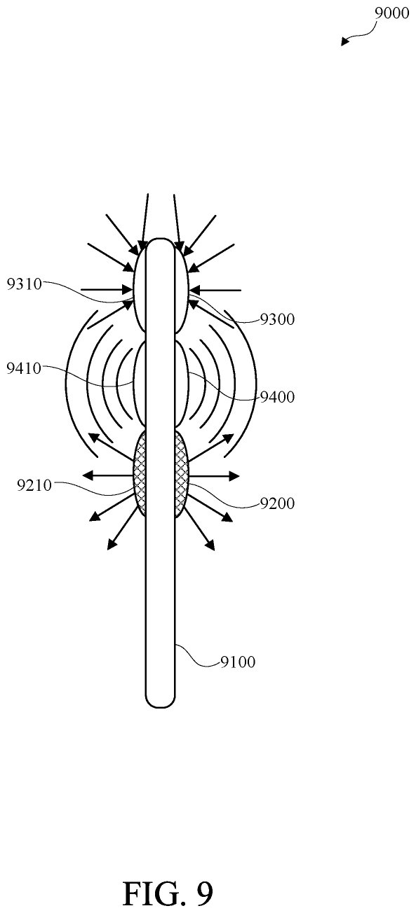

FIG. 9 shows a diagram of another example of a spherical fisheye non-visible light depth detection device 9000 in accordance with this disclosure. The spherical fisheye non-visible light depth detection device 9000, may be similar to the spherical fisheye non-visible light depth detection device 9000 shown in FIG. 9, except as described herein or otherwise clear from context.

The spherical fisheye non-visible light depth detection device 9000 includes a device housing 9100, a first hemispherical-fisheye non-visible-light-depth-detection unit 9200, a second hemispherical-fisheye non-visible-light-depth-detection unit 9210, a first hemispherical fisheye non-visible light detection unit 9300, a second hemispherical fisheye non-visible light detection unit 9310, a first hemispherical fisheye non-visible light flood projection unit 9400, and a first hemispherical fisheye non-visible light flood projection unit 9410.

FIG. 10 shows a diagram of an example of a spherical fisheye non-visible light projection unit 10000 in accordance with this disclosure. A spherical, or omnidirectional, fisheye non-visible light depth detection device, such as the spherical fisheye non-visible light depth detection device 8000 shown in FIG. 8, or the spherical fisheye non-visible light depth detection device 9000 shown in FIG. 9, may include the spherical fisheye non-visible light projection unit 10000. For example, the first hemispherical-fisheye non-visible-light-depth-detection unit 8200 and the second hemispherical-fisheye non-visible-light-depth-detection unit 8210 of the spherical fisheye non-visible light depth detection device 8000 shown in FIG. 8 may be implemented as the spherical fisheye non-visible light projection unit 10000.

The spherical fisheye non-visible light projection unit 10000 includes an enclosure 10100, a non-visible light source 10200, one or more first lenses 10300, a mirror 10400, a first hemispherical portion 10500, and a second hemispherical portion 10600. The non-visible light source 10200 and the first lenses 10300 are oriented along a first axis 10700.

The first hemispherical portion 10500 includes one or more second lenses 10510 and a first diffractive optical element 10520. The second hemispherical portion 10600 includes one or more third lenses 10610 and a second diffractive optical element 10620. The first hemispherical portion 10500 and the second hemispherical portion 10600 are oriented along an optical axis, as indicated by the broken line at 10800.

The non-visible light projected by the non-visible light source 10200 along the first axis 10700 is directed, such as split and reflected, by the mirror 10400 toward the first hemispherical portion 10500 and second hemispherical portion 10600 respectively. The non-visible light emitted by the non-visible light source 10200 and directed by the mirror 10400 toward the first hemispherical portion 10500 and second hemispherical portion 10600 respectively is refracted by the lenses 10510, 10610 respectively to form a combined field of projection of 360 degrees longitudinally and 360 degrees laterally. The non-visible light forming the field of projection is rectified to form static dot cloud pattern by the respective diffractive optical elements 10520, 10620. Respective example light paths are indicated by the directional lines extending from the non-visible light source 10200, passing through the lenses 10300, directed by the mirror 10400, passing through the lenses 10510, 10610, and passing through and extending from the diffractive optical elements 10520, 10620.

The non-visible light source 10200 generates the non-visible light in a plane and the combination of the lenses 10300, 10510, 10610, the mirror 10400, and the diffractive optical elements 10520, 10620 maps the light emitted by non-visible light source 10200 to the spherically distributed static dot cloud pattern.

FIG. 11 shows a diagram of an example of a spherical fisheye non-visible light detection unit 11000 in accordance with this disclosure. A spherical, or omnidirectional, fisheye non-visible light depth detection device, such as the spherical fisheye non-visible light depth detection device 8000 shown in FIG. 8, or the spherical fisheye non-visible light depth detection device 9000 shown in FIG. 9, may include the spherical fisheye non-visible light detection unit 11000. For example, the first hemispherical fisheye non-visible light detection unit 8300 and the second hemispherical fisheye non-visible light detection unit 8310 of the spherical fisheye non-visible light depth detection device 8000 shown in FIG. 8 may be implemented as the spherical fisheye non-visible light detection unit 11000.

The spherical fisheye non-visible light detection unit 11000 includes an enclosure 11100, a first hemispherical portion 11200, a second hemispherical portion 11300, a mirror 11400, one or more first lenses 11500, and a non-visible light receiver 11600. The non-visible light receiver 11600 and the first lenses 11500 are oriented along a first axis 11700.

The first hemispherical portion 11200 includes one or more second lenses 11210 and a first non-visible light pass filter 11220. The second hemispherical portion 11300 includes one or more third lenses 11310 and a second non-visible light pass filter 11320. The first hemispherical portion 11200 and the second hemispherical portion 11300 are oriented along an optical axis, as indicated by the broken line at 11800.

The non-visible light pass filters 11220, 11320 may receive light, which may include non-visible light, such as infrared light. For example, the non-visible light pass filters 11220, 11320 may receive infrared light from a static dot cloud pattern reflected by proximate external objects (not shown) subsequent to emission from a non-visible light projection unit, such as the spherical fisheye non-visible light projection unit 10000 shown in FIG. 10.

The light received by the non-visible light pass filters 11220, 11320 is filtered by the non-visible light pass filters 11220, 11320 to exclude visible light and pass through non-visible light. The non-visible light passed through the non-visible light pass filters 11220, 11320 is focused by the second and third lenses 11210, 11310 respectively on the mirror 11400 and directed to the non-visible light receiver 11600 via the first lenses 11500. The combination of the non-visible light pass filters 11220, 11320, the mirror 11400, and the lenses 11210, 11310, 11500 maps the spherical field of view of the spherical fisheye non-visible light detection unit 11000 to the plane of the non-visible light receiver 11600.

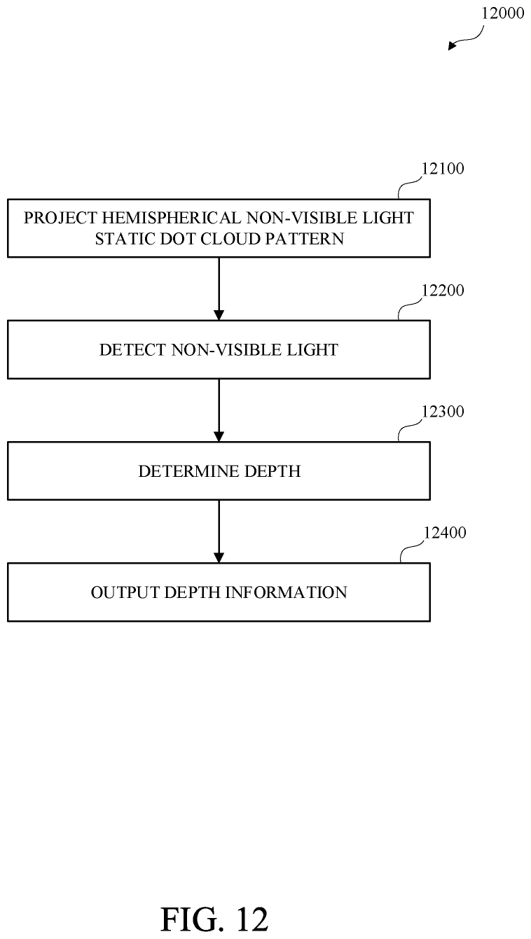

FIG. 12 shows a diagram of an example of fisheye non-visible light depth detection 12000 in accordance with this disclosure. Fisheye non-visible light depth detection 12000 may be implemented in a non-visible light based depth detection device, such as a user device, such as the hemispherical fisheye non-visible light depth detection device 3000 shown in FIG. 3, the hemispherical fisheye non-visible light depth detection device 4000 shown in FIG. 4, the spherical fisheye non-visible light depth detection device 8000 shown in FIG. 8, or the spherical fisheye non-visible light depth detection device 9000 shown in FIG. 9.

Fisheye non-visible light depth detection 12000 includes projecting a hemispherical or spherical non-visible light static dot cloud pattern at 12100, detecting non-visible light at 12200, determining three-dimensional depth information at 12300, and outputting the three-dimensional depth information at 12400.

Projecting the hemispherical or spherical non-visible light static dot cloud pattern at 12100 includes emitting, from a non-visible light source, such as the non-visible light source 5200 shown in FIG. 5 or the non-visible light source 10200 shown in FIG. 10, non-visible light, such as infrared light. In some embodiments, such as in spherical embodiments, projecting the hemispherical or spherical non-visible light static dot cloud pattern at 12100 includes directing, such as by a mirror, such as the mirror 10400 shown in FIG. 10, the emitted non-visible light towards a first hemispherical portion of the non-visible light based depth detection device, such as the first hemispherical portion 10500 shown in FIG. 10, and a second hemispherical portion of the non-visible light based depth detection device, such as the second hemispherical portion 10600 shown in FIG. 10. Projecting the hemispherical or spherical non-visible light static dot cloud pattern at 12100 includes refracting, such as by one or more lenses, such as the lenses 5300 shown in FIG. 5 or the lenses 10300, 10510, 10610 shown in FIG. 6, the emitted non-visible light to form a hemispherical or spherical field of projection. Projecting the hemispherical or spherical non-visible light static dot cloud pattern at 12100 includes rectifying or filtering, such as by a diffractive optical element, such as the diffractive optical element 5400 shown in FIG. 5 or the diffractive optical elements 10520, 10620 shown in FIG. 6, the non-visible light in the hemispherical or spherical field of projection to form the projected hemispherical or spherical non-visible light static dot cloud pattern.

The points of non-visible light of the projected hemispherical or spherical non-visible light static dot cloud pattern, or a portion thereof, may be reflected toward the non-visible light based depth detection device by one or more external objects, or portions thereof, in the environment of the non-visible light based depth detection device.

Detecting the non-visible light at 12200 includes receiving light, including reflected non-visible light that was projected at 12100. Detecting the non-visible light at 12200 includes filtering the received light, such as by a non-visible light pass filter, such as the non-visible light pass filter 6200 shown in FIG. 6 or the non-visible light pass filters 11220, 111320 shown in FIG. 11, to exclude light other than the non-visible light, such as visible light, and pass through the non-visible light. Detecting non-visible light at 12200 includes focusing the received non-visible light onto a planar surface of a non-visible light detector, such as the non-visible light receiver 6400 shown in FIG. 6 or the non-visible light receiver 11600 shown in FIG. 11, using one or more lenses, such as the lenses 6300 shown in FIG. 6 or the lenses 11210, 11310, 11500 shown in FIG. 11. In some embodiments, such as in spherical embodiments, the receive light may be received and filtered by a first hemispherical portion of the non-visible light based depth detection device, such as the first hemispherical portion 11200 shown in FIG. 11, and a second hemispherical portion of the non-visible light based depth detection device, such as the second hemispherical portion 11300 shown in FIG. 11, focused by the respective hemispherical portions on a mirror, such as the mirror 11400 shown in FIG. 11, and directed by the mirror to the non-visible light receiver.

Determining the three-dimensional depth information at 12300 may include determining respective results using one or more mapping functions, wherein θ indicates an angle in radians between a point of reflected light and the optical axis of the camera, f indicates the focal length of the lens, and R indicates the radial position of a corresponding detected light on the sensor, such as an equidistant mapping function, which may be expressed as R=f·0, a stereographic mapping function, which may be expressed as R=2f·tan(θ/2) an orthographic mapping function, which may be expressed as R=f·sin(θ), an equisolid mapping function, which may be expressed as R=2f·sin(θ/2) or any other hemispherical or spherical mapping function.

Although fisheye non-visible light depth detection is described in the context of structure-light based fisheye non-visible light depth detection herein, other fisheye non-visible light depth detection techniques, such as dynamic pattern structured-light depth detection and time-of-flight (ToF) depth detection may be used. In some implementations, the structured or dynamic light pattern may be a dot cloud pattern, gray/color coded light striping pattern, or the like.

For example, fisheye non-visible light time-of-flight depth detection may include projecting hemispherical non-visible light using a hemispherical fisheye non-visible light flood projection unit, such as the hemispherical fisheye non-visible light flood projection unit 4400 shown in FIG. 4 or the hemispherical fisheye non-visible light flood projection unit 7000 shown in FIG. 7, or projecting spherical non-visible light using a spherical fisheye non-visible light flood projection unit, identifying a temporal projection point corresponding to projecting the non-visible light, receiving reflected non-visible light using a hemispherical fisheye non-visible light detection unit, such as the hemispherical fisheye non-visible light detection unit 6000 shown in FIG. 6, or a spherical fisheye non-visible light detection unit, such as the spherical fisheye non-visible light detection unit 11000 shown in FIG. 11, determining one or more temporal reception points corresponding to receiving the reflected non-visible light, and determining the depth information based on differences between the temporal projection point and the temporal reception points. Spatial information corresponding to detecting or receiving the reflected non-visible light may be mapped to the operational environment of the fisheye non-visible light time-of-flight depth detection unit, and the difference between the temporal projection point and the temporal reception point corresponding to a respective spatial location may be identified as depth information for the corresponding spatial point.

The three-dimensional depth information may be output at 12400. For example, the three-dimensional depth information may be stored in a data storage unit. In another example, the three-dimensional depth information may be transmitted to another component of the apparatus.

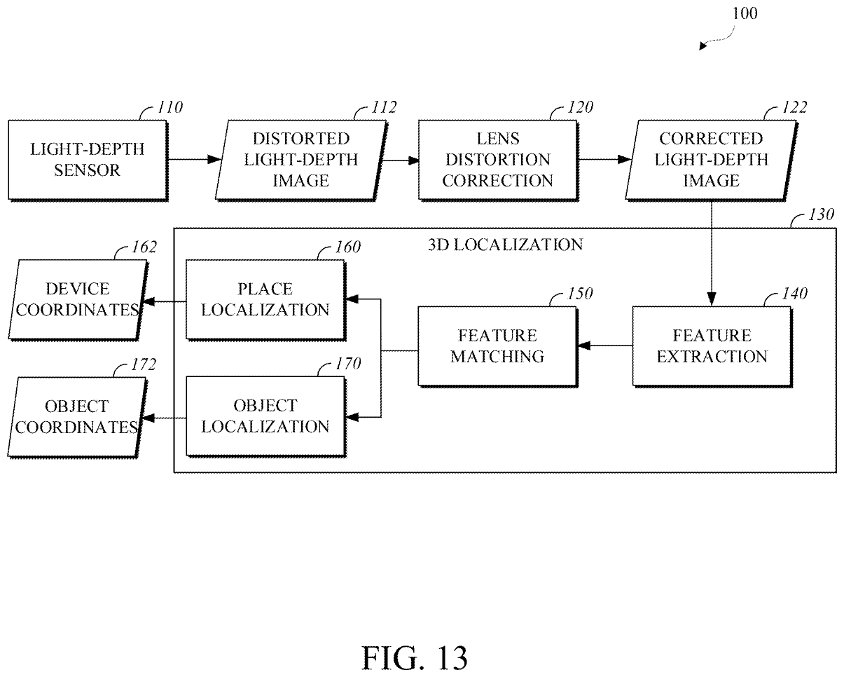

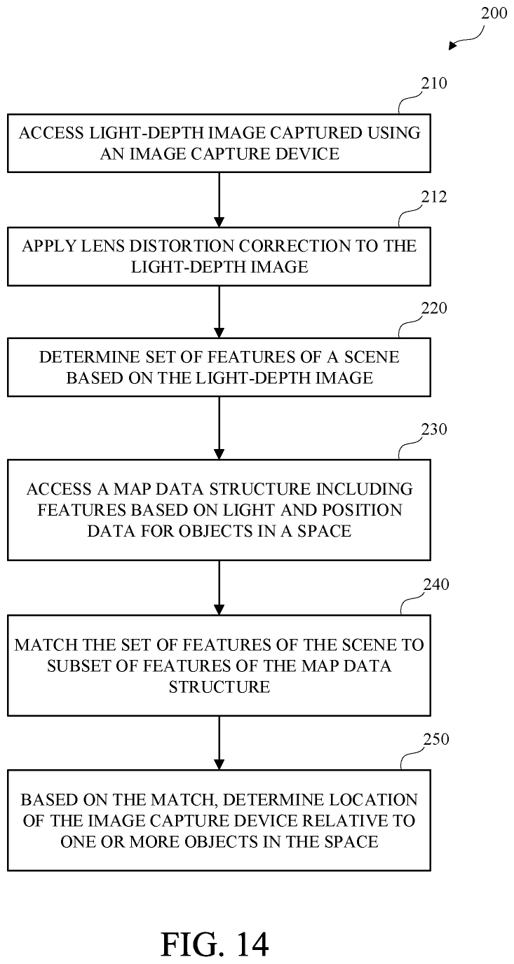

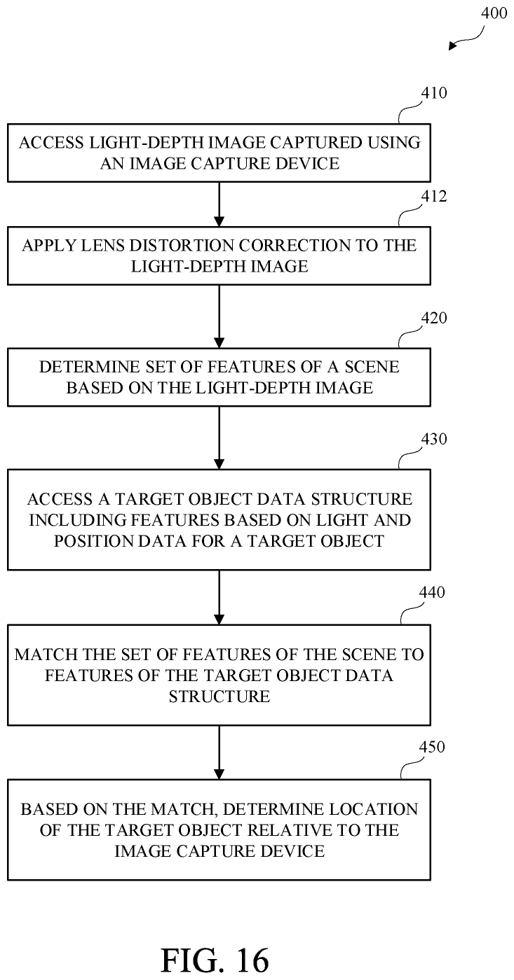

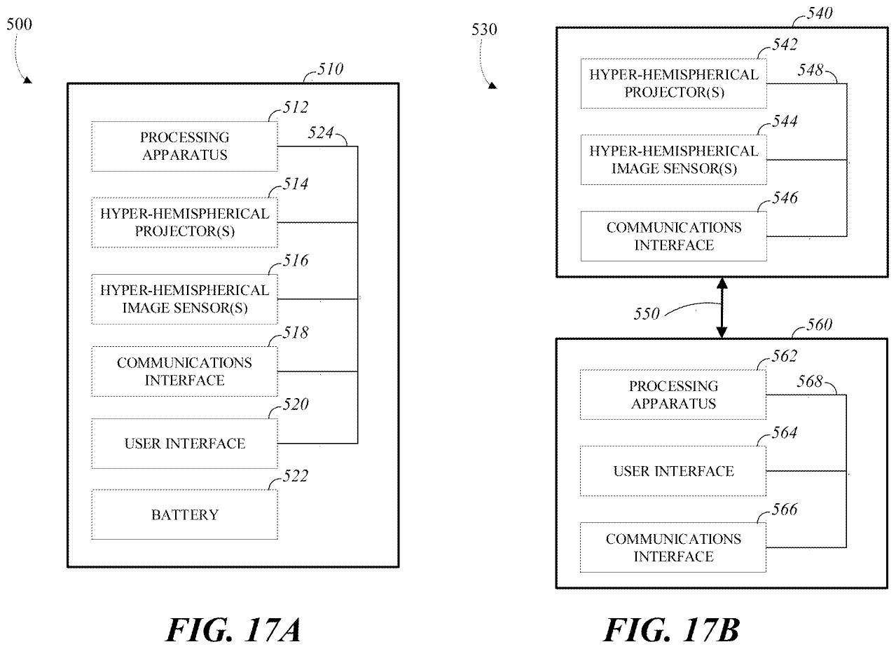

FIG. 13 is a block diagram of an example of a system 100 for three-dimensional localization using light-depth images (e.g., images that includes one or more visible light channels and a non-visible light depth channel). The system 100 includes a light-depth sensor 110 that captures distorted light-depth image 112, a lens distortion correction module 120 configured to apply lens distortion correction processing to the distorted light-depth image 112 to obtain corrected light-depth image 122, and a three-dimensional (3D) localization module 130 that is configured to determine device coordinates 162 indicating a location of a device including the light-depth sensor 110 and object coordinates 172 indicating a location of a target object (e.g., a user's car or desired item for sale in a store). The three-dimensional localization module 130 may include a feature extraction module 140; a feature matching module 150, a place localization module 160, and an object localization module. For example, the system 100 may be configured to implement the process 200 of FIG. 14. For example, the system 100 may be configured to implement the process 400 of FIG. 16. For example, the system 100 may be configured to implemented as part of the system 500 of FIG. 17A. For example, the system 100 may be configured to implemented as part of the system 530 of FIG. 17B.

The system 100 includes a light-depth sensor 110 that includes a light sensor (e.g., an RGB image sensor configured to sense visible light in three color channels) and a distance/depth sensor (e.g., a non-visible light projector with a non-visible light sensor that determine distances using structured light and/or time-of-flight techniques). For example, the light-depth sensor 110 may include one or more lenses through which light detected by the light-depth sensor 110 is refracted. For example, the one or more lenses may include a hyper-hemispherical lens (e.g., a fisheye lens or a spherical lens). For example, the light-depth sensor 110 may include the hemispherical fisheye non-visible light depth detection device 3000 of FIG. 3. For example, the light-depth sensor 110 may include the hemispherical fisheye non-visible light depth detection device 4000 of FIG. 4. For example, the light-depth sensor 110 may include the hemispherical-fisheye non-visible-light-depth-detection unit 5000 of FIG. 5. For example, the light-depth sensor 110 may include the hemispherical fisheye non-visible light detection unit 6000 of FIG. 6. For example, the light-depth sensor 110 may include the hemispherical fisheye non-visible light flood projection unit 7000 of FIG. 7. For example, the light-depth sensor 110 may include the spherical fisheye non-visible light depth detection device 8000 of FIG. 8. For example, the light-depth sensor 110 may include the spherical fisheye non-visible light depth detection device 9000 of FIG. 9. For example, the light-depth sensor 110 may include the spherical fisheye non-visible light projection unit 10000 of FIG. 10. For example, the light-depth sensor 110 may include and/or the spherical fisheye non-visible light detection unit 11000 of FIG. 11. The light-depth sensor 110 is configured to capture the distorted light-depth image 112.

The distorted light-depth image 112 includes a non-visible light depth channel representing distances of objects in a scene viewed from the light-depth sensor (e.g., distances determined using structured light or time-of-flight techniques with a light projector and light sensor). The distorted light-depth image 112 also includes one or more visible light channels (e.g., RGB, YUV, or a single black and white luminance channel) representing light reflected from surfaces of the objects in the scene viewed from the image capture device. The one or more visible light channels be based on detection of light in various bands of the electromagnetic spectrum (e.g., visible light, infrared light, and/or other non-visible light). For example, the one or more lights channels may be temporally and spatially synchronized with the non-visible light depth channel (e.g., they may be based on data captured at the same or nearly the same time and represent different properties of a common viewed scene). In some implementations, the non-visible light depth channel and the one or more visible light channels are spatially synchronized by applying a transformation to align pixels of the non-visible light depth channel with corresponding pixels of the one or more visible light channels, where a light sensor used for depth sensor is offset from a light sensor used to detect light reflected in the one or more visible light channels. For example, a transformation to align pixels in the image channels from different component sensors of light-depth sensor 110 may be determined by using a calibration to determine with sufficient precision the topology of the light depth sensor and how the components sensors are oriented in relation to each other. For example, the distorted light-depth image 112 may be distorted in the sense that refraction of the detected light through a lens of the light-depth sensor 110 has caused a deviation in the captured image from rectilinear projection of the scene.

The system 100 includes a lens distortion correction module 120 that is configured to apply lens distortion correction to the distorted light-depth image 112. For example, applying lens distortion correction may include applying a non-linear transformation to the distorted light-depth image 112 to obtain a corrected light-depth image 122. For example, a transformation for lens distortion correction may be determined based on the geometry of a lens (e.g., a fisheye lens) used to refract the detected light on which the distorted light-depth image 112 is based. In some implementations, different lenses may be used to collect light on which different channels of the distorted light-depth image 112 are based, and different transformations associated with the lenses may be applied to the respective channels of the distorted light-depth image 112. For example, corrected light-depth image may be a rectilinear projection of the scene. For example, the lens distortion correction module 120 may apply lens distortion correction to the light-depth image prior to determining a set of features of the scene in a space based on the light-depth image.

The system 100 includes a three-dimensional localization module 130 that is configured to determine a location of a device including the light-depth sensor 110 and/or a location of a target object in relation to the device based on a light-depth image. The three-dimensional localization module 130 may take the corrected light-depth image 122 as input and pass it into the feature extraction module 140. The feature extraction module 140 may be configured to determine a set of features of the scene based on the corrected light-depth image 122. In some implementations, the feature extraction module 140 may include a convolutional neural network, and may be configured to input data based on the corrected light-depth image 122 (e.g., the corrected light-depth image 122 itself, a scaled version of the corrected light-depth image 122, and/or other data derived from the corrected light-depth image 122) to convolutional neural network to obtain the set of features of the scene. For example, the convolutional neural network may include activations. For example, the convolutional neural network may include one or more convolutional layers, one or more pooling layers, and/or one or more fully connected layers. In some implementations, the feature extraction module 140 may be configured to apply a scale-invariant feature transformation (SIFT) to the light-depth image to obtain features in the set of features of the scene. In some implementations, the feature extraction module 140 may be configured to determine a speeded up robust features (SURF) descriptor based on the light-depth image to obtain features in the set of features of the scene. In some implementations, the feature extraction module 140 may be configured to determine a histogram of oriented gradients (HOG) based on the light-depth image to obtain features in the set of features of the scene.

The three-dimensional localization module 130 may pass the set of features of the scene to the feature matching module 150 that is configured to match the set of features of the scene to features, or a subset of the features of a map data structure and/or to features of a target object. For example, the set of features of the scene may be matched to the features of the map data structure that correspond to an object (e.g., furniture or the walls of a room) associated with a position within a map. The match may indicate that a location corresponding to the position in the map appears within the view from the device. For example, a target object (e.g., a user's car) may be registered with a record including features that can be matched to find the target object within the scene. In some implementations, the set of features of the scene is matched by determining a distance metric (e.g., Euclidean distance) to compare the set of features of the scene to features of a target object or an object represented in a map data structure, and then comparing the distance metric to a threshold. In some implementations, a neural network may be used to match the set of features of the scene. For example, the neural network for matching the set of features may use a ranking loss function.

When a match of the set of features of the scene to features of the map occurs, the place localization module 160 may be invoked to determine a location of the device including the light-depth sensor 110 based on a position in a map associated with the matched subset of the features of the map data structure. For example, the features of the scene that have been matched may be associated with pixels that correspond to an angle or orientation with respect to the image capture device. For example, the non-visible light depth channel values for these pixels may also provide information about the distance between the image capture device and a matched object of the map data structure. The angle and the distance associated with the match may be used to determine a location of the image capture device relative to the matched object(s). For example, the location may be specified in device coordinates 162. In some implementations, the device coordinates 162 are geo-referenced. In some implementations, a simultaneous localization and mapping (SLAM) algorithm may be used to determine the location of the image capture device and generate the device coordinates 162. The device coordinates 162 may then be used to show the position of the image capture device on a graphical representation of the map of the map data structure to inform a user of the current position. In some implementations, a destination is specified (e.g., based on user input) and a route is determined from the current location of the image capture device to the destination based on the map data structure. For example, a determined route may be illustrated on a graphical representation of the map that is presented to a user to guide the user to the destination from the location of the image capture device.

When a match of the set of features of the scene to features a target object (e.g., a car in a parking lot or a desired product in a store), the object localization module 170 may be invoked to determine a location of target object relative to the device including the light-depth sensor 110. For example, the features of the scene that have been matched may be associated with pixels that correspond to an angle or orientation with respect to the image capture device. For example, the non-visible light depth channel values for these pixels may also provide information about the distance between the image capture device and a matched target object. The angle and the distance associated with the match may be used to determine a location of the target object relative to the image capture device. For example, the location may be specified in object coordinates 172. In some implementations, the object coordinates 172 are geo-referenced. For example, the object coordinates 172 may then be used to show the position of the image capture device on a graphical representation of the map of the map data structure to inform a user of the position of the target object (e.g., where is their car, or where is the product they are searching for). In some implementations, the object may be highlighted or annotated in an augmented reality display based on the object coordinates 172.

FIG. 14 is a flow chart of an example of a process 200 for three-dimensional localization of a device using light-depth images captured using the device. The process 200 includes accessing 210 a light-depth image; applying 212 lens distortion correction to the light-depth image; determining 220 a set of features of a scene in a space based on the light-depth image; accessing 230 a map data structure that includes features based on light data and position data for objects in a space; matching 240 the set of features of the scene to features of the map data structure; and, based on matching the set of features of the scene to the subset of features of the map data structure, determining 250 a location of the image capture device relative to objects in the space. For example, the process 200 may be implemented using the system 100 of FIG. 13. For example, the process 200 may be implemented using the system 500 of FIG. 17A. For example, the process 200 may be implemented using the system 530 of FIG. 17B.

The process 200 includes accessing 210 a light-depth image. The light-depth image includes a non-visible light depth channel representing distances of objects in a scene viewed from an image capture device, and the light-depth image includes one or more visible light channels, which are temporally and spatially synchronized with the non-visible light depth channel, representing light reflected from surfaces of the objects in the scene viewed from the image capture device. For example, the one or more visible light channels may include a luminance channel. In some implementations, the one or more visible light channels include YUV channels. In some implementations, the one or more visible light channels include a red channel, a blue channel, and a green channel. For example, the non-visible light depth channel and the one or more visible light channels may be spatially synchronized in the sense that corresponding pixels of each channel correspond to approximately the same viewing angles from a light-depth image capture device. For example, the light-depth image may be accessed 210 by receiving light-depth image from the one or more image sensors (e.g., the one or more hyper-hemispherical image sensors 516) via a bus (e.g., the bus 524). In some implementations, the light-depth image may be accessed 210 via a communications link (e.g., the communications link 550). For example, the light-depth image may be accessed 210 via a wireless or wired communications interface (e.g., Wi-Fi, Bluetooth, USB, HDMI, Wireless USB, Near Field Communication (NFC), Ethernet, a radio frequency transceiver, and/or other interfaces). In some implementations, the light-depth image may be accessed 210 directly from the one or more hyper-hemispherical image sensors without intermediate signal processing. In some implementations, the light-depth image may be accessed 210 after being subjected to intermediate signal processing (e.g., processing to determine non-visible light depth channel data based on structured light data collected from a scene or time of flight data, or processing to align data collected with sensors at different positions on a light-depth image capture device). In some implementations, the light-depth image may be accessed 210 by retrieving the light-depth image from a memory or other data storage apparatus.

The process 200 includes applying 212 lens distortion correction to the light-depth image prior to determining the set of features of the scene in a space based on the light-depth image. For example, an image capture device that is used to capture the light-depth image may include a hyper-hemispherical lens that is used to capture the light-depth image, which may cause the light-depth image to deviate from a rectilinear projection of the scene. For example, applying 212 lens distortion correction may include applying a transformation to the data of each channel of the light-depth image to unwarp them to obtain a rectilinear projection of the scene. For example, a transformation for lens distortion correction may be determined based on the geometry of a lens (e.g., a fisheye lens) used to refract the detected light on which the light-depth image is based. In some implementations, different lenses may be used to collect light on which different channels of the light-depth image are based, and different transformations associated with the lenses may be applied to the respective channels of the light-depth image.

The process 200 includes determining 220 a set of features of the scene in a space based on the light-depth image. The set of features is determined 220 based on the non-visible light depth channel and at least one of the one or more visible light channels. In some implementations, determining 220 the set of features of the scene may include applying a convolutional neural network to the light-depth image to obtain the set of features of the scene. For example, the convolutional neural network include activations. For example, the convolutional neural network may include one or more convolutional layers, one or more pooling layers, and/or one or more fully connected layers. In some implementations, determining 220 the set of features of the scene may include applying a scale-invariant feature transformation (SIFT) to the light-depth image to obtain features in the set of features of the scene. In some implementations, determining 220 the set of features of the scene may include determining a speeded up robust features (SURF) descriptor based on the light-depth image to obtain features in the set of features of the scene. In some implementations, determining 220 the set of features of the scene may include determining a histogram of oriented gradients (HOG) based on the light-depth image to obtain features in the set of features of the scene.

The process 200 includes accessing 230 a map data structure that includes features based on light data and position data for the objects in the space. For example, the map data structure may include features that were extracted from light-depth images in the same format as the accessed 210 light-depth image. For example, subsets of the features of the map data structure may be associated with respective positions in the space modeled by the map data structure. For example, the map data structure may be accessed 230 by receiving map data via a bus. In some implementations, the map data structure may be accessed 230 via a communications link. For example, the map data structure may be accessed 230 via a wireless or wired communications interface (e.g., Wi-Fi, Bluetooth, USB, HDMI, Wireless USB, Near Field Communication (NFC), Ethernet, a radio frequency transceiver, and/or other interfaces) from a map server. In some implementations, the map data structure may be accessed 230 by retrieving the map data from a memory or other data storage apparatus (e.g., memory of the processing apparatus 512). And the position data may include non-visible light depth channel data, and the light data may include the at least one of one or more visible light channels data, and the non-visible light depth channel data is determined by obtaining hemispherical non-visible light image in the light-depth image, the one or more visible light channels data is determined by obtaining hemispherical visible light image in the light-depth image. For example, obtaining the hemispherical non-visible light depth image is shown in FIG. 12, and the hemispherical non-visible light can be hemispherical infrared light static structured light pattern.

The process 200 includes matching 240 the set of features of the scene to features of the map data structure to get matching data. For example, the set of features of the scene may be matched 240 to the features of the map data structure that correspond to an object associated with a position within a map. The match may indicate that a location corresponding to the position in the map appears within the view from the device. In some implementations, the set of features of the scene is matched by determining a distance metric (e.g., Euclidean distance) to compare the set of features of the scene to features of an object represented in a map data structure, and then comparing the distance metric to a threshold. In some implementations, a neural network may be used to match 240 the set of features of the scene. For example, the neural network for matching 240 the set of features may use a ranking loss function.

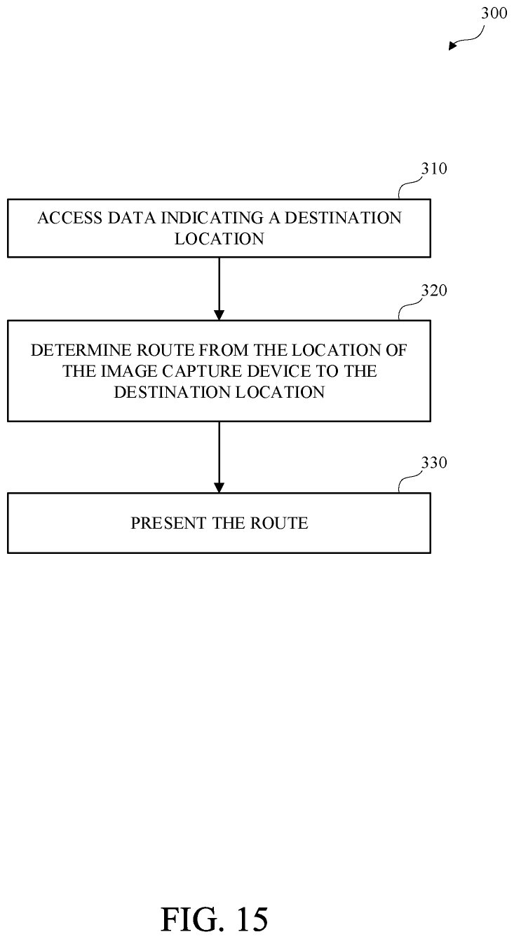

The process 200 includes, based on matching 240 the set of features of the scene to the subset of features of the map data structure, determining 250 a location of the image capture device relative to objects in the space based on the matching result. For example, the features of the scene that have been matched may be associated with pixels that correspond to an angle or orientation with respect to the image capture device. For example, the non-visible light depth channel values for these pixels may also provide information about the distance between the image capture device and a matched object of the map data structure. The angle and the distance associated with the match may be used to determine a location of the image capture device relative to the matched object(s) of the map data structure. In some implementations, the location includes geo-referenced coordinates. In some implementations, the location of the image capture device may then be used to generate a graphical map representation based on the map data structure that includes and visual indication of the location of the image capture device within the map. In some implementations, the location of the image capture device may then be used to determine a route from the location to a destination at a position in the map stored by the map data structure, and the route may be displayed as part of a graphical representation of the map. For example, the process 300 of FIG. 15 may be implemented to determine a route based on the determined 450 location of the image capture device.

FIG. 15 is a flow chart of an example of a process 300 for generating a route based on localization data. The process 300 includes accessing 310 data indicating a destination location; determining 320 a route from the location of the image capture device to the destination location based on the map data structure; and presenting 330 the route. For example, the process 300 may be implemented using the system 500 of FIG. 17A. For example, the process 300 may be implemented using the system 530 of FIG. 17B.

The process 300 includes accessing 310 data indicating a destination location. For example, the data indicating a destination location may include coordinates in a map and/or geo-referenced coordinates. For example, the data indicating the destination location may be accessed 310 by receiving data indicating the destination location from a user interface (e.g., the user interface 520 or the user interface 564) via a bus (e.g., the bus 524 or the bus 568). In some implementations, the data indicating the destination location may be accessed 310 via a communications link (e.g., using the communications interface 518 or the communications interface 566). For example, the data indicating the destination location may be accessed 310 via a wireless or wired communications interface (e.g., Wi-Fi, Bluetooth, USB, HDMI, Wireless USB, Near Field Communication (NFC), Ethernet, a radio frequency transceiver, and/or other interfaces). In some implementations, the data indicating the destination location may be accessed 310 by retrieving the data indicating the destination location from a memory or other data storage apparatus (e.g., memory of the processing apparatus 512 or the processing apparatus 562).

The process 300 includes determining 320 a route from the location of the image capture device to the destination location based on the map data structure. For example, the location of the image capture device may be determined 250 using the process 200 of FIG. 14. For example, the route may be determined based on the location of image capture device, the destination location and data from the map data structure regarding obstructions and/or traversable paths. For example, an A* algorithm may be used to select a route from the location of the image capture device to the destination location.

The process 300 includes presenting 330 the route. For example, the route may be presented 330 as part of a graphical representation of the map of the map data structure (e.g., as a sequence of highlighted or colored line segments overlaid on a map). For example, the route may be presented 330 as a sequence of instructions displayed as text. For example, the route may be presented 330 as a sequence of instructions played as synthesized speech through a microphone. For example, the route may be presented 330 via a user interface (e.g., the user interface 520 or the user interface 564). For example, the route may be presented 330 by transmitting a data structure encoding a graphical representation of the route to a personal computing device (e.g., a smartphone or a tablet) for display to a user.

FIG. 16 is a flow chart of an example of a process 400 for three-dimensional localization of an object using light-depth images. The process 400 includes accessing 412 a light-depth image; applying 412 lens distortion correction to the light-depth image; determining 420 a set of features of a scene in a space based on the light-depth image; accessing 430 a target object data structure that includes features based on light data and position data for a target object; matching 440 the set of features of the scene to features of the target object data structure; and, based on matching the set of features of the scene to features of the target object data structure, determining 450 a location of the target object relative to the image capture device. For example, the process 400 may be implemented using the system 100 of FIG. 13. For example, the process 400 may be implemented using the system 500 of FIG. 17A. For example, the process 400 may be implemented using the system 530 of FIG. 17B.

The process 400 includes accessing 410 a light-depth image. The light-depth image includes a non-visible light depth channel representing distances of objects in a scene viewed from an image capture device, and the light-depth image includes one or more visible light channels, which are temporally and spatially synchronized with the non-visible light depth channel, representing light from reflected surfaces of the objects in the scene viewed from the image capture device. For example, the one or more visible light channels may include a luminance channel. In some implementations, the one or more visible light channels include YUV channels. In some implementations, the one or more visible light channels include a red channel, a blue channel, and a green channel. For example, the non-visible light depth channel and the one or more visible light channels may be spatially synchronized in the sense that corresponding pixels of each channel correspond to approximately the same viewing angles from a light-depth image capture device. For example, the light-depth image may be accessed 410 by receiving light-depth image from the one or more image sensors (e.g., the one or more hyper-hemispherical image sensors 516) via a bus (e.g., the bus 524). In some implementations, the light-depth image may be accessed 410 via a communications link (e.g., the communications link 550). For example, the light-depth image may be accessed 410 via a wireless or wired communications interface (e.g., Wi-Fi, Bluetooth, USB, HDMI, Wireless USB, Near Field Communication (NFC), Ethernet, a radio frequency transceiver, and/or other interfaces). In some implementations, the light-depth image may be accessed 410 directly from the one or more hyper-hemispherical image sensors without intermediate signal processing. In some implementations, the light-depth image may be accessed 410 after being subjected to intermediate signal processing (e.g., processing to determine non-visible light depth channel data based on structured light data collected from a scene or time of flight data, or processing to align data collected with sensors at different positions on a light-depth image capture device). In some implementations, the light-depth image may be accessed 410 by retrieving the light-depth image from a memory or other data storage apparatus.

The process 400 includes applying 412 lens distortion correction to the light-depth image prior to determining the set of features of the scene in a space based on the light-depth image. For example, an image capture device that is used to capture the light-depth image may include a hyper-hemispherical lens that is used to capture the light-depth image, which may cause the light-depth image to deviate from a rectilinear projection of the scene. For example, applying 412 lens distortion correction may include applying a transformation to the data of each channel of the light-depth image to unwarp them to obtain a rectilinear projection of the scene. For example, a transformation for lens distortion correction may be determined based on the geometry of a lens (e.g., a fisheye lens) used to refract the detected light on which the light-depth image is based. In some implementations, different lenses may be used to collect light on which different channels of the light-depth image are based, and different transformations associated with the lenses may be applied to the respective channels of the light-depth image.

The process 400 includes determining 420 a set of features of the scene in a space based on the light-depth image. The set of features is determined 420 based on the non-visible light depth channel and at least one of the one or more visible light channels. In some implementations, determining 420 the set of features of the scene may include applying a convolutional neural network to the light-depth image to obtain the set of features of the scene. For example, the set of features of the scene may include activations of the convolutional neural network generated in response to the light-depth image. For example, the convolutional neural network may include one or more convolutional layers, one or more pooling layers, and/or one or more fully connected layers. In some implementations, determining 420 the set of features of the scene may include applying a scale-invariant feature transformation (SIFT) to the light-depth image to obtain features in the set of features of the scene. In some implementations, determining 420 the set of features of the scene may include determining a speeded up robust features (SURF) descriptor based on the light-depth image to obtain features in the set of features of the scene. In some implementations, determining 420 the set of features of the scene may include determining a histogram of oriented gradients (HOG) based on the light-depth image to obtain features in the set of features of the scene.

The process 400 includes accessing 430 a target object data structure that includes features based on light data and position data for a target object (e.g., a user's car that the user desires to find in a parking lot or a product that the user desires to find in a store). For example, the target object data structure may include features that were extracted from light-depth images in the same format as the accessed 410 light-depth image. In some implementations, the target object data structure includes multiple sets of features for the target object corresponding to different respective perspectives on the target object. For example, the target object data structure may include a list of perspectives of the target object, and for each perspective there is a set of features determined based on a light-depth image taken from the respective perspective. In some implementations, the target object data structure includes features stored in a three-dimensional data structure. For example, the target object data structure may include a three-dimensional record of features for the target object that is determined based on light-depth images captured from variety of perspectives on the target object. For example, a user may perform a registration process for their car to create a target object data for their car, which may include capturing light-depth images of the car from a variety of perspectives (e.g., from the front, from the back, from the right side, from the left side, and/or every ten degrees around the car). For example, a product manufacturer may perform a registration process for their product to generate a target object data structure for their product and make this target object data structure available to users from a server (e.g., a webserver) to enable the user to search for the product in a store using a light-depth camera. For example, For example, the target object data structure may be accessed 430 by receiving data via a bus. In some implementations, the target object data structure may be accessed 430 via a communications link. For example, the target object data structure may be accessed 430 via a wireless or wired communications interface (e.g., Wi-Fi, Bluetooth, USB, HDMI, Wireless USB, Near Field Communication (NFC), Ethernet, a radio frequency transceiver, and/or other interfaces) from a map server. In some implementations, the target object data structure may be accessed 430 by retrieving the target object data structure from a memory or other data storage apparatus (e.g., memory of the processing apparatus 512).

The process 400 includes matching 440 the set of features of the scene to features of the target object data structure. For example, the set of features of the scene may be matched 440 to features of the target object data structure that correspond to the target object (e.g., matched to the features for one of the perspectives in a list of perspectives of the target object, or matched to subset of features of three-dimensional features of the target object stored in the target object data structure). The match may indicate that the target object appears within the view from the device. In some implementations, the set of features of the scene is matched by determining a distance metric (e.g., Euclidean distance) to compare the set of features of the scene to features of the target object represented in a target object data structure, and then comparing the distance metric to a threshold. In some implementations, a neural network may be used to match 440 the set of features of the scene. For example, the neural network for matching 440 the set of features may use a ranking loss function.

The process 400 includes, based on matching 440 the set of features of the scene to features of the target object data structure, determining 450 a location of the target object relative to the image capture device. For example, the features of the scene that have been matched may be associated with pixels that correspond to a viewing angle or orientation with respect to the image capture device. For example, the non-visible light depth channel values for these pixels may also provide information about the distance between the image capture device and a matched target object of the target object data structure. The angle and the distance associated with the match may be used to determine a location of the target object relative to the image capture device. In some implementations, the location includes geo-referenced coordinates.

FIG. 17A is a block diagram of an example of a system 500 configured for capture of light-depth images. The system 500 includes a light-depth image capture device 510 (e.g., a handheld camera), which may, for example, be the hemispherical fisheye non-visible light depth detection device 3000 of FIG. 3, the hemispherical fisheye non-visible light depth detection device 4000 of FIG. 4, the spherical fisheye non-visible light depth detection device 8000 of FIG. 8, the spherical fisheye non-visible light depth detection device 9000 of FIG. 9, the spherical fisheye non-visible light projection unit 10000 of FIG. 10, or the spherical fisheye non-visible light detection unit 11000 of FIG. 11. The light-depth image capture device 510 includes a memory that stores one or more programs, a processing apparatus 512 that includes one or more processors, one or more hyper-hemispherical projectors 514, one or more hyper-hemispherical image sensors 516, a communications interface 518, a user interface 520 and a battery 522.

The light-depth image capture device 510 includes a processing apparatus 512 that is configured to execute one or more programs to receive light-depth images captured using the one or more hyper-hemispherical projectors 514 and/or the one or more hyper-hemispherical image sensors 516. The processing apparatus 512 may be configured to perform image signal processing (e.g., filtering, tone mapping, stitching, and/or encoding) to generate output images based on image data from the one or more hyper-hemispherical image sensors 516. The light-depth image capture device 510 includes a communications interface 518 for transferring light-depth images or data based on light-depth images to other devices. The light-depth image capture device 510 includes a user interface 520 to allow a user to control light-depth image capture functions and/or view images. The light-depth image capture device 510 includes a battery 522 for powering the light-depth image capture device 510. The components of the light-depth image capture device 510 may communicate with each other via the bus 524.

The processing apparatus 512 may include one or more processors having single or multiple processing cores. The processing apparatus 512 may include memory, such as a random-access memory device (RAM), flash memory, or another suitable type of storage device such as a non-transitory computer-readable memory. The memory of the processing apparatus 512 may include executable instructions and data that can be accessed by one or more processors of the processing apparatus 512. For example, the processing apparatus 512 may include one or more dynamic random access memory (DRAM) modules, such as double data rate synchronous dynamic random-access memory (DDR SDRAM). In some implementations, the processing apparatus 512 may include a digital signal processor (DSP). In some implementations, the processing apparatus 512 may include an application specific integrated circuit (ASIC). For example, the processing apparatus 512 may include a custom graphical processing unit (GPU).

The one or more hyper-hemispherical projectors 514 may be configured to project light that is reflected off objects in a scene to facilitate capture of light-depth images. For example, the one or more hyper-hemispherical projectors 514 may project structured light to facilitate distance measurements for object viewed by the light-depth image capture device 510. For example, the one or more hyper-hemispherical projectors 514 may include a hyper-hemispherical non-visible light projector (e.g., an infrared projector). In some implementations, the hyper-hemispherical non-visible light projector is configured to project infrared light in a structured light pattern, a non-visible light sensor (e.g., of the one or more hyper-hemispherical image sensors 516) is configured to detect infrared light, and the processing apparatus 512 is configured to determine the non-visible light depth channel based on infrared light detected using the non-visible light sensor. For example, the one or more hyper-hemispherical projectors 514 may include the spherical fisheye non-visible light projection unit 10000 of FIG. 10. For example, the one or more hyper-hemispherical projectors 514 may include the hemispherical-fisheye non-visible-light-depth-detection unit 5000. For example, the one or more hyper-hemispherical projectors 514 may include the hemispherical fisheye non-visible light flood projection unit 7000.

The one or more hyper-hemispherical image sensors 516 may be configured to detect light that is reflected off objects in a scene to facilitate capture of light-depth images. For example, the one or more hyper-hemispherical image sensors 516 may include a hyper-hemispherical non-visible light sensor (e.g., an infrared sensor). The hyper-hemispherical non-visible light sensor may be configured to detect non-visible light (e.g., structured infrared light) that has been projected by the one or more hyper-hemispherical projectors 514 and reflected of objects in a scene viewed by the light-depth image capture device 510. For example, the processing apparatus 512 may apply signal processing to images captured by the hyper-hemispherical non-visible light sensor to determine distance data of non-visible light depth channel of a resulting light-depth image. For example, the one or more hyper-hemispherical image sensors 516 may include a hyper-hemispherical visible light sensor. The hyper-hemispherical visible light sensor may be used to capture visible light reflected of objects in a scene viewed by the light-depth image capture device 510. For example, one or more visible light channels of a light-depth image may be determined based on image data captured by the hyper-hemispherical visible light sensor. For example, the hyper-hemispherical visible light sensor may capture one or more visible light channels that include a red channel, a blue channel, and a green channel. For example, the hyper-hemispherical visible light sensor may capture one or more visible light channels that include a luminance channel. In some implementations, the non-visible light sensor and the visible light sensor share a common hyper-hemispherical lens through which the non-visible light sensor receives infrared light and the visible light sensor receives visible light. For example, the one or more hyper-hemispherical image sensors 516 may include the spherical fisheye non-visible light detection unit 11000 of FIG. 11. For example, the one or more hyper-hemispherical image sensors 516 may include the hemispherical fisheye non-visible light detection unit 6000.

The communications interface 518 may enable communications with a personal computing device (e.g., a smartphone, a tablet, a laptop computer, or a desktop computer). For example, the communications interface 518 may be used to receive commands controlling light-depth image capture and processing in the light-depth image capture device 510. For example, the communications interface 518 may be used to transfer light-depth image data to a personal computing device. For example, the communications interface 518 may include a wired interface, such as a high-definition multimedia interface (HDMI), a universal serial bus (USB) interface, or a FireWire interface. For example, the communications interface 518 may include a wireless interface, such as a Bluetooth interface, a ZigBee interface, and/or a Wi-Fi interface.

The user interface 520 may include an LCD display for presenting images and/or messages to a user. For example, the user interface 520 may include a button or switch enabling a person to manually turn the light-depth image capture device 510 on and off. For example, the user interface 520 may include a shutter button for snapping pictures.

The battery 522 may power the light-depth image capture device 510 and/or its peripherals. For example, the battery 522 may be charged wirelessly or through a micro-USB interface.

The image capture system 500 may implement some or all of the processes described in this disclosure, such as the process 200 of FIG. 14, the process 300 of FIG. 15, or the process 400 of FIG. 16.

FIG. 17B is a block diagram of an example of a system 530 configured for capture of light-depth images. The system 530 includes a light-depth image capture device 540 (e.g., a handheld camera) and a personal computing device 560 that communicate via a communications link 550. For example, the light-depth image capture device 540 may include the hemispherical fisheye non-visible light depth detection device 3000 of FIG. 3, the hemispherical fisheye non-visible light depth detection device 4000 of FIG. 4, the spherical fisheye non-visible light depth detection device 8000 of FIG. 8, the spherical fisheye non-visible light depth detection device 9000 of FIG. 9, the spherical fisheye non-visible light projection unit 10000 of FIG. 10, or the spherical fisheye non-visible light detection unit 11000 of FIG. 11. The light-depth image capture device 540 includes one or more hyper-hemispherical projectors 542, one or more hyper-hemispherical image sensors 544, and a communications interface 546. Image signals from the one or more hyper-hemispherical image sensors 544 may be passed to other components of the light-depth image capture device 540 via a bus 548. The personal computing device 560, includes a processing apparatus 562, a user interface 564, and a communications interface 566. In some implementations, the processing apparatus 562 may be configured to perform image signal processing (e.g., filtering, tone mapping, stitching, and/or encoding) to generate light-depth images based on image data from the one or more hyper-hemispherical image sensors 544.

The one or more hyper-hemispherical projectors 542 may be configured to project light that is reflected off objects in a scene to facilitate capture of light-depth images. For example, the one or more hyper-hemispherical projectors 542 may project structured light to facilitate distance measurements for object viewed by the light-depth image capture device 540. For example, the one or more hyper-hemispherical projectors 542 may include a hyper-hemispherical non-visible light projector (e.g., an infrared projector). In some implementations, the hyper-hemispherical non-visible light projector is configured to project infrared light in a structured light pattern, a non-visible light sensor (e.g., of the one or more hyper-hemispherical image sensors 544) is configured to detect infrared light, and the processing apparatus 562 is configured to determine the non-visible light depth channel based on infrared light detected using the non-visible light sensor. For example, the one or more hyper-hemispherical projectors 542 may include the spherical fisheye non-visible light projection unit 10000 of FIG. 10. For example, the one or more hyper-hemispherical projectors 542 may include the hemispherical-fisheye non-visible-light-depth-detection unit 5000. For example, the one or more hyper-hemispherical projectors 542 may include the hemispherical fisheye non-visible light flood projection unit 7000.

The one or more hyper-hemispherical image sensors 544 may be configured to detect light that is reflected off objects in a scene to facilitate capture of light-depth images. For example, the one or more hyper-hemispherical image sensors 544 may include a hyper-hemispherical non-visible light sensor (e.g., an infrared sensor). The hyper-hemispherical non-visible light sensor may be configured to detect non-visible light (e.g., structured infrared light) that has been projected by the one or more hyper-hemispherical projectors 542 and reflected of objects in a scene viewed by the light-depth image capture device 540. For example, the processing apparatus 562 may apply signal processing to images captured by the hyper-hemispherical non-visible light sensor to determine distance data of non-visible light depth channel of a resulting light-depth image. For example, the one or more hyper-hemispherical image sensors 544 may include a hyper-hemispherical visible light sensor. The hyper-hemispherical visible light sensor may be used to capture visible light reflected of objects in a scene viewed by the light-depth image capture device 540. For example, one or more visible light channels of a light-depth image may be determined based on image data captured by the hyper-hemispherical visible light sensor. For example, the hyper-hemispherical visible light sensor may capture one or more visible light channels that include a red channel, a blue channel, and a green channel. For example, the hyper-hemispherical visible light sensor may capture one or more visible light channels that include a luminance channel. In some implementations, the non-visible light sensor and the visible light sensor share a common hyper-hemispherical lens through which the non-visible light sensor receives infrared light and the visible light sensor receives visible light. For example, the one or more hyper-hemispherical image sensors 544 may include the spherical fisheye non-visible light detection unit 11000 of FIG. 11. For example, the one or more hyper-hemispherical image sensors 544 may include the hemispherical fisheye non-visible light detection unit 6000.

The communications link 550 may be a wired communications link or a wireless communications link. The communications interface 546 and the communications interface 566 may enable communications over the communications link 550. For example, the communications interface 546 and the communications interface 566 may include an HDMI port or other interface, a USB port or other interface, a FireWire interface, a Bluetooth interface, a ZigBee interface, and/or a Wi-Fi interface. For example, the communications interface 546 and the communications interface 566 may be used to transfer image data from the light-depth image capture device 540 to the personal computing device 560 for image signal processing (e.g., filtering, tone mapping, stitching, and/or encoding) to generate light-depth images based on image data from the one or more hyper-hemispherical image sensors 544.

The processing apparatus 562 may include one or more processors having single or multiple processing cores. The processing apparatus 562 may include memory, such as RAM, flash memory, or another suitable type of storage device such as a non-transitory computer-readable memory. The memory of the processing apparatus 562 may include executable instructions and data that can be accessed by one or more processors of the processing apparatus 562. For example, the processing apparatus 562 may include one or more DRAM modules, such as DDR SDRAM. In some implementations, the processing apparatus 562 may include a DSP. In some implementations, the processing apparatus 562 may include an integrated circuit, for example, an ASIC. For example, the processing apparatus 562 may include a graphical processing unit (GPU). The processing apparatus 562 may exchange data (e.g., image data) with other components of the personal computing device 560 via a bus 568.

The personal computing device 560 may include a user interface 564. For example, the user interface 564 may include a touchscreen display for presenting images and/or messages to a user and receiving commands from a user. For example, the user interface 564 may include a button or switch enabling a person to manually turn the personal computing device 560 on and off. In some implementations, commands (e.g., start recording video, stop recording video, or snap photograph) received via the user interface 564 may be passed on to the light-depth image capture device 540 via the communications link 550.

The light-depth image capture device 540 and/or the personal computing device 560 may be used to implement some or all of the processes described in this disclosure, such as the process 200 of FIG. 14, the process 300 of FIG. 15, or the process 400 of FIG. 16.

Aspects, features, elements, and embodiments of methods, procedures, or algorithms disclosed herein, may be implemented in a computer program, software, or firmware incorporated in a computer-readable storage medium for execution by a computer or processor, and may take the form of a computer program product accessible from, such as a tangible computer-usable or computer-readable medium.

As used herein, the terminology “computer” or “computing device” includes any unit, or combination of units, capable of performing any method, or any portion or portions thereof, disclosed herein. As used herein, terminology “user device”, “mobile device”, or “mobile computing device” includes but is not limited to a user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such as one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “instructions” may include directions for performing any method, or any portion or portions thereof, disclosed herein, and may be realized in hardware, software, or any combination thereof. For example, instructions may be implemented as information stored in the memory, such as a computer program, that may be executed by a processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. Portions of the instructions may be distributed across multiple processors on the same machine or different machines or across a network such as a local area network, a wide area network, the Internet, or a combination thereof.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

What is claimed is:

1. A method for three-dimensional localization, comprising:
accessing a light-depth image, wherein the light-depth image includes a non-visible light depth channel representing distances of objects in a scene viewed from an image capture device, and the light-depth image includes one or more visible light channels that are temporally and spatially synchronized with the non-visible light depth channel, wherein the one or more visible light channels represent light reflected from surfaces of the objects in the scene viewed from the image capture device;
determining a set of features of the scene in a space based on the light-depth image, wherein the set of features is determined based on the non-visible light depth channel and at least one of the one or more visible light channels;
accessing a map data structure that includes features based on light data and position data for the objects in the space; wherein the position data includes non-visible light depth channel data, and the light data includes the at least one of one or more visible light channels data;
accessing matching data derived by matching the set of features of the scene to features of the map data structure; and
determining a location of the objects in the space based on the matching data.

2. The method of claim 1, wherein the non-visible light depth channel data is determined by obtaining hemispherical non-visible light image in the light-depth image, the one or more visible light channels data is determined by obtaining hemispherical visible light image in the light-depth image.

3. The method of claim 2, wherein obtaining hemispherical non-visible light depth image comprises:
projecting hemispherical non-visible light;
in response to projecting the hemispherical non-visible light, detecting reflected non-visible light; and
obtaining hemispherical non-visible light depth image by determining three-dimensional depth information based on the detected reflected non-visible light and the projected hemispherical non-visible light.

4. The method of claim 3, wherein projecting the hemispherical non-visible light comprises:
projecting a hemispherical infrared light static structured light pattern.

5. The method of claim 1, wherein determining the set of features of the scene based on the light-depth image comprises:
applying a convolutional neural network to the light-depth image to determine the set of features of the scene, and wherein the convolutional neural network includes activations.

6. The method of claim 1, wherein determining the set of features of the scene based on the light-depth image comprises:
applying a scale-invariant feature transformation to the light-depth image.

7. The method of claim 1, wherein the image capture device includes a hyper-hemispherical lens that is used to capture the light-depth image, and the method comprising:
applying lens distortion correction to the light-depth image prior to determining the set of features of the scene based on the light-depth image.

8. The method of claim 1, comprising:
accessing data indicating a destination location;
determining a route from the location of the image capture device to the destination location based on the map data structure; and
presenting the route.

9. A system comprising:
a hyper-hemispherical non-visible light projector, configured to project non-visible light in a structured light pattern;
a hyper-hemispherical non-visible light sensor, configured to detect non-visible light;
a hyper-hemispherical visible light sensor, configured to detect visible light; and
one or more processors; and
a memory; and
one or more programs, wherein the one or more programs including instructions are stored in the memory and configured to be executed by the one or more processors for:
accessing a light-depth image that is captured using the hyper-hemispherical non-visible light sensor and the hyper-hemispherical visible light sensor, wherein the light-depth image includes a non-visible light depth channel representing distances of objects in a scene viewed from an image capture device that includes the hyper-hemispherical non-visible light sensor, and the hyper-hemispherical visible light sensor, and the light-depth image includes one or more visible light channels, that are temporally and spatially synchronized with the non-visible light depth channel, wherein the one or more visible light channels represent light reflected from surfaces of the objects in the scene viewed from the image capture device;
determining a set of features of the scene in a space based on the light-depth image, wherein the set of features is determined based on the non-visible light depth channel and at least one of the one or more visible light channels;
accessing a map data structure that includes features based on light data and position data for the objects in the space; wherein the position data includes non-visible light depth channel data, and the light data includes at least one of the one or more visible light channels data;
accessing matching data by matching the set of features of the scene to features of the map data structure; and
determining a location of the objects in the space based on the matching data.

10. The system of claim 9, wherein the hyper-hemispherical non-visible light sensor and the hyper-hemispherical visible light sensor share a common hyper-hemispherical lens through which the hyper-hemispherical non-visible light sensor receives infrared light and the hyper-hemispherical visible light sensor receives visible light.

11. The system of claim 9, wherein the one or more visible light channels include a luminance channel.

12. The system of claim 9, wherein the processing apparatus is configured to determine the set of features of the scene based on the light-depth image by performing operations comprising:
applying a convolutional neural network to the light-depth image to determine the set of features of the scene, and wherein the convolutional neural network includes activations.

13. The system of claim 9, wherein the processing apparatus is configured to determine the set of features of the scene based on the light-depth image by performing operations comprising:
applying a scale-invariant feature transformation to the light-depth image.

14. The system of claim 9, wherein the image capture device includes a hyper-hemispherical lens that is used to capture the light-depth image, and the processing apparatus is configured to:
apply lens distortion correction to the light-depth image prior to determining the set of features of the scene based on the light-depth image.

15. The system of claim 9, wherein the location includes geo-referenced coordinates.

16. The system of claim 9, the processing apparatus is configured to:
access data indicating a destination location;
determine a route from the location of the image capture device to the destination location based on the map data structure; and
present the route.

17. A non-transitory computer-readable medium, comprising:
one or more processors;
a memory; and
one or more programs, wherein the one or more programs including instructions are stored in the memory and configured to be executed by the one or more processors for:
accessing a light-depth image that is captured using the hyper-hemispherical non-visible light sensor and the hyper-hemispherical visible light sensor, wherein the light-depth image includes a non-visible light depth channel representing distances of objects in a scene viewed from an image capture device that includes a hyper-hemispherical non-visible light sensor, a hyper-hemispherical non-visible light projector and a hyper-hemispherical visible light sensor, and the light-depth image includes one or more visible light channels that are temporally and spatially synchronized with the non-visible light depth channel, wherein the one or more visible light channels represent light reflected from surfaces of the objects in the scene viewed from the image capture device;
determining a set of features of the scene in a space based on the light-depth image, wherein the set of features is determined based on the depth channel and at least one of the one or more visible light channels;
accessing a map data structure that includes features based on light data and position data for the objects in the space; wherein the position data includes non-visible light depth channel data, and the light data includes at least one of the one or more visible light channels data;
accessing matching data derived by matching the set of features of the scene to features of the map data structure; and
determining a location of the objects in the space based on the matching data.

18. The method of claim 17, wherein the non-visible light depth channel data is determined by obtaining hemispherical non-visible light image in the light-depth image, the one or more visible light channels data is determined by obtaining hemispherical visible light image in the light-depth image.

19. The method of claim 18, wherein obtaining hemispherical non-visible light depth image comprises:
projecting hemispherical non-visible light;
in response to projecting the hemispherical non-visible light, detecting reflected non-visible light; and
obtaining hemispherical non-visible light depth image by determining three-dimensional depth information based on the detected reflected non-visible light and the projected hemispherical non-visible light.

20. The method of claim 19, wherein projecting the hemispherical non-visible light comprises:
projecting a hemispherical infrared light static structured light pattern.
